(19) United States
(12) Patent Application Publication
(10) Pub. No.: US 2009/0080914 A1
(43) Pub. Date: Mar. 26, 2009

(54) IMAGE PROCESSING APPARATUS AND IMAGE FORMING APPARATUS

(76) Inventors: Yoshikazu Harada, Nara-shi (JP); Norio Tomita, Nara-shi (JP); Yoshiteru Kikuchi, Yamatokoriyama-shi (JP); Tetsushi Ito, Nara-shi (JP); Tetsuya Yamaguchi, Ikoma-gun (JP)

Correspondence Address: BIRCH STEWART KOLASCH & BIRCH, PO BOX 747, FALLS CHURCH, VA, 22040-0747, US

(21) Appl. No.: 12/207,697

(22) Filed: Sep. 10, 2008

(30) Foreign Application Priority Data
Sep. 26, 2007 (JP) 2007-249621

(51) Int. Cl. G03G 15/00

(52) U.S. Cl. 399/39

(57) ABSTRACT

A sub CPU of an image forming section forms a toner image based on test line data on an intermediate transfer belt, detects an inclination of the formed toner image for each color component, calculates an adjustment indicative value for correcting the detected inclination for each color component, and outputs the adjustment indicative values to the BK adjusting section, C adjusting section, M adjusting section, and Y adjusting section, respectively, of an inclination adjusting section. The BK adjusting section, C adjusting section, M adjusting section, and Y adjusting section generate, based on the respective adjustment indicative values obtained from the sub CPU, adjustment amounts for an inclination adjustment process to be executed on image data, execute the inclination adjustment process based on the generated adjustment amounts, and output the obtained image data to the respective LDs of an exposure unit.

### CROSS-REFERENCE TO RELATED APPLICATIONS

This non-provisional application claims priority under 35 U.S.C. §119(a) on Patent Application No. 2007-249621 filed in Japan on Sep. 26, 2007, the entire contents of which are hereby incorporated by reference.

### BACKGROUND

1. Technical Field

The present invention relates to an image processing apparatus for performing a process of correcting an inclination of an image on image data, and an image forming apparatus comprising the image processing apparatus.

2. Description of Related Art

An image forming apparatus, such as a copying machine and a printer, employing an electrophotographic process charges a photosensitive drum as an image carrier and forms an electrostatic latent image by exposing the charged photosensitive drum based on image data. The image forming apparatus supplies toner (developer) to the electrostatic latent image to form a toner image (developer image). By transferring and fixing the toner image thus formed on the photosensitive drum onto paper, the image is formed on the paper.

A color image forming apparatus employing an intermediate transfer system has been put into practical use. In the intermediate transfer system, toner images based on image data decomposed into a plurality of color components are formed on photosensitive drums provided for the respective color components, the toner images of the respective color components are temporarily stacked on an intermediate transfer body, and then the stack of the toner images of the respective colors are collectively retransferred from the intermediate transfer body to paper. In such a color image forming apparatus, since a toner image is formed individually for each color component, it is possible to increase the speed of the image formation process.

In such an image forming apparatus, the toner image formed on the photosensitive drum may be inclined with respect to a main scanning direction (direction orthogonal to the rotation direction of the photosensitive drum) due to a displacement of the angle of the rotation axis of the photosensitive drum, a displacement of the installation angle of an optical scanning system for exposing the photosensitive drum, etc. Further, in a color image forming apparatus, if the formation positions of toner images of the respective color components are displaced from each other due to an inclination of the toner image of each color component, out-of-color registration occurs and causes a problem of image quality degradation.

As a method for adjusting the inclination of a toner image, there are an optical adjustment method and a method of making an adjustment on image data. In the optical adjustment method, an LSU (Laser Scanning Unit) adjusts the irradiation position of a laser beam exposing the photosensitive drum, and therefore an adjustment mechanism needs to be included in the LSU and there arises a problem that the size of the LSU becomes larger. On the other hand, in the method of making an adjustment on image data, there is a problem that a line may appear at a position where the inclination is adjusted on image data. The reason for this will be described below.

First, image processing that is performed by the image forming apparatus on image data to be processed will be explained. One example of the image processing is line processing in which, as disclosed in Japanese Patent Application Laid-Open No. 05-336360 (1993), the densities of a plurality of adjacent scan lines in a sub-scanning direction are shifted for image data. When the line processing is performed, even if the image data before the processing is uniform mid-density image data, there is a problem that a scan line with high density and a scan line with low density appear at certain intervals in the image data after the processing.

Next, the following will explain a conventional inclination adjustment process. FIG. 1A, FIG. 1B, FIG. 1C and FIG. 2 are explanatory views showing the conventional inclination adjustment process. FIG. 1A shows an enlarged view of a part of a toner image formed on the photosensitive drum based on image data before executing the inclination adjustment process. FIG. 1B shows an enlarged view of a part of a toner image formed on the photosensitive drum based on image data after executing the inclination adjustment process on the image data. FIG. 1C shows an entire view of the toner image shown in FIG. 1B. FIG. 2 illustrates an enlarged view of scan lines A, B, and C in the toner image shown in FIG. 1B, and also shows an example of density distributions of black and cyan components in the pixels on the scan line A.

The broken line A in FIG. 1A shows a scan line with no inclination in the main scanning direction. As shown in FIG. 1A, the toner image formed on the photosensitive drum based on image data before executing the inclination adjustment process is inclined with respect to the main scanning direction. Moreover, it can be understood that, when the conventional inclination adjustment process is performed, image data as shown in FIG. 1B is obtained, in which data of a plurality of scan lines which are adjacent in the image data before executing the inclination adjustment process appear at certain intervals in a single scan line (line data). More specifically, the scan line A includes data on n line, data on n+1 line, and data on n+2 line in this order from the left; the scan line B includes data on n−1 line, data on n line, and data on n+1 line in this order from the left; and the scan line C includes data on n−2 line, data on n−1 line, and data on n line in this order from the left.

Here, if the above-mentioned line processing is performed on image data before executing the inclination adjustment process, the image data before executing the inclination adjustment process has, for example, high density in the n line and low density in the n+1 line and n−1 line. When the conventional inclination adjustment process is performed on such image data, data with high density and data with low density appear alternately in the main scanning direction of a single scan line, and image data having gaps B and B caused by the differences in the densities in the main scanning direction is obtained.

Since an edge effect is produced in such gaps B and B, density peaks P and P are formed as shown in the density distribution of FIG. 2. These peaks are noticeable as lines C and C running in the sub-scanning direction shown in FIG. 1C. Note that part of the scan lines A, B, and C based on image data of a plurality of colors (black component and cyan component) is shown in FIG. 2, and, if the density peaks P and P of the respective color components overlap, the positions where the lines C and C are produced by the image data of the respective color components also overlap each other, and therefore the image quality is further degraded.

Hence, Japanese Laid-Open Patent Application No. 2000-253231 proposes an apparatus which performs, after executing the inclination adjustment on the image data, a smoothing process on a gap portion caused by the inclination adjustment. With the use of such an apparatus, it is possible to correct the inclination of the images of the respective color components in the electrophotographic process, and it is also possible to eliminate the gaps caused by the correction process.

### SUMMARY

As described above, the method of optically adjusting the inclination of an image has the problem that the size of the LSU becomes larger. Although the method of making an adjustment on image data does not have the problem of larger circuit scale, it has a problem that lines appear at positions where the inclination is adjusted on the image data as described above. In the apparatus disclosed in Japanese Laid-Open Patent Application No. 2000-253231, it is possible to eliminate gaps and lines caused by the inclination adjustment, but it is necessary to separately perform a process for eliminating the gaps and lines.

The present invention has been made with the aim of solving the above problems, and it is an object of the invention to provide an image processing apparatus and an image forming apparatus capable of correcting the inclination of an image while reducing lines generated in the sub-scanning direction of the image, without increasing the circuit scale.

An image processing apparatus according to the present invention is an image processing apparatus for performing, on image data, a process of correcting an inclination of an image based on the image data, and characterized by comprising: means for obtaining image data including a plurality of line data for each of a plurality of color components; segmenting means for dividing each line data into a plurality of segments, correcting means for performing a process of correcting an inclination for each of the segments divided by the segmenting means; and setting means for setting positions for the segmenting means to divide each line data, for each color component.

According to the present invention, in the structure in which each line data in the image data including a plurality of line data for each of a plurality of color components is divided into a plurality of segments and an inclination of an image is corrected in each segment, positions for dividing each line data in correcting the inclination of the image are set for each color component. Therefore, the positions of gaps caused by the differences in density when correcting the inclination of the image can be varied among the respective color components.

The image processing apparatus according to the present invention is characterized by comprising line memories for storing a plurality of line data, wherein the correcting means includes means for combining a plurality of line data stored in the line memories.

According to the present invention, since the inclination of an image is corrected by combining a plurality of line data stored in the line memories, there is no need to provide a mechanism for correcting the inclination of an image or perform complicated image processing. Moreover, since the inclination correction process can be started at the time a plurality of line data are stored in the line memories, it is possible to perform processing at high speed.

The image processing apparatus according to the present invention is characterized by comprising detecting means for detecting an inclination direction and an inclination amount of an image based on image data, wherein the correcting means performs a process of correcting the inclination direction and inclination amount detected by the detecting means.

According to the present invention, since the detected inclination direction and inclination amount of the image are corrected, it is possible to accurately correct an inclination that actually occurs in the image.

An image processing apparatus according to the present invention is characterized by comprising means for forming a test image based on predetermined test line data, and means for detecting positions of both end portions in a longitudinal direction of the formed test image, along a direction crossing the longitudinal direction, wherein the detecting means detects an inclination direction and an inclination amount of the image based on the positions of both end portions in the longitudinal direction of the formed test image, along the direction crossing the longitudinal direction.

According to the present invention, the direction and amount of an inclination that occurs in an image are detected based on a test image formed based on predetermined line data and then the detected inclination direction and inclination amount are corrected. It is thus possible to accurately correct an inclination that actually occurs in the image.

The image processing apparatus according to the present invention is characterized by comprising means for calculating, based on the inclination direction and inclination amount detected by the detecting means, an adjustment amount for a position the segmenting means divides each line data for each color component, wherein the setting means sets, based on the calculated adjustment amount, positions for the segmenting means to divide each line data for each color component.

According to the present invention, positions at which each line data is divided in correcting the inclination of an image are set for each color component based on the detected inclination direction and inclination amount of the image. Therefore, for each color component, it is possible to set, based on an inclination that actually occurs in the image, positions of gaps caused by the differences in density when correcting the inclination.

An image processing apparatus according to the present invention is characterized in that the detecting means detects an inclination direction and an inclination amount of an image based on image data of one color component, and the correcting means performs a process of correcting image data of other color component according to the inclination direction and inclination amount detected by the detecting means.

According to the present invention, the inclination direction and the inclination amount of an image of one color component are detected, and a process of correcting image data of other color component according to the detected inclination direction and inclination amount is performed. Hence, it is possible to control the inclination of image data of other color component to match the inclination of one color component, it is possible to reduce deviations in inclination among the respective color components, it is possible to eliminate the need of a circuit for performing the inclination adjustment process on image data of one color component, and it is possible to reduce the circuit scale.

The image processing apparatus according to the present invention is characterized in that the above-mentioned one color component is black component. According to the present invention, it is possible to reduce deviations in inclination of image data of other color components with respect to black image data.

An image forming apparatus according to the present invention is characterized by comprising any one of the above-described image processing apparatuses, and forming an image based on image data processed by the image processing apparatus on a recording medium. As described above, since the positions of gaps caused by the differences in density in correcting the inclination of an image are varied among the respective color components, it is possible to reduce lines that occur at the gap sections when an image is formed based on such image data on a recording medium, and it is possible to form a good-quality image.

An image forming apparatus according to the present invention is an image forming apparatus comprising an intermediate transfer belt and transfer means for transferring a developer image based on image, data onto the intermediate transfer belt, for forming on a recording medium an image based on the developer image transferred onto the intermediate transfer belt, and characterized in that the transfer means transfers a test developer image based on predetermined test line data onto the intermediate transfer belt, and the image forming apparatus comprises: means for detecting positions of both end portions in a longitudinal direction of the test developer image transferred onto the intermediate transfer belt, along a direction crossing the longitudinal direction; detecting means for detecting an inclination direction and an inclination amount of the developer image based on the image data, based on the detected positions; means for obtaining image data including a plurality of line data for each of a plurality of color components; segmenting means for dividing each line data into a plurality of segments; correcting means for performing a process of correcting the inclination direction and inclination amount detected by the detecting means for each of the segments divided by the segmenting means; and setting means for setting positions for the segmenting means to divide each line data for each color component, wherein the transfer means transfers the developer image based on the image data corrected by the correcting means onto the intermediate transfer belt.

According to the present invention, the image forming apparatus which forms an image on a recording medium after temporarily transferring a developer image based on image data onto the intermediate transfer belt detects, based on a test developer image formed on the intermediate transfer belt based on predetermined test line data, detects the direction and amount of an inclination that actually occurs in an image when image formation is performed, and corrects the detected inclination direction and inclination amount. It is therefore possible to certainly correct an inclination that actually occurs in the image. Moreover, in the structure in which each line data in image data including a plurality of line data for each of a plurality of color components is divided into a plurality of segments and the inclination of an image is corrected in each segment, the positions of gaps caused by the differences in density in correcting the inclination of the image can be varied among the respective color components by setting positions for dividing each line data in correcting the inclination of the image individually for each color component.

In the present invention, by arranging the positions of gaps caused by the differences in density in correcting the inclination of the image to be different among the respective color components, the positions of density peaks appearing at the gap sections can be varied among the respective color components. Thus, it is possible to correct the inclination of the image while reducing lines appearing at such gap sections, and it is possible to improve the image quality. Further, since the inclination of the image is corrected by image processing, it is possible to avoid an increase in the circuit scale.

The above and further objects and features will more fully be apparent from the following detailed description with accompanying drawings.

### BRIEF DESCRIPTION OF THE SEVERAL VIEWS OF THE DRAWINGS

FIG. 1A, FIG. 1B and FIG. 1C are explanatory views for explaining a conventional inclination adjustment process;

FIG. 2 is an explanatory view for explaining the conventional inclination adjustment process;

FIG. 3 is a vertical sectional view showing an example of the internal structure of an image forming apparatus according to the present invention;

FIG. 4 is a block diagram showing an example of the structure of a control system of the image forming apparatus according to the present invention.

FIG. 5 is a block diagram showing an example of the structure of a control system of an image forming section;

FIG. 6 is a block diagram showing an example of the structure of a control system of an inclination adjusting section;

FIG. 7A and FIG. 7B are explanatory views for explaining an inclination adjustment process performed by a correcting section;

FIG. 8 is an explanatory view for explaining an inclination adjustment process performed by the inclination adjusting section;

FIG. 9 is an explanatory view for explaining an inclination adjustment process performed by the inclination adjusting section;

FIG. 10 is a schematic view showing an example of a toner image based on test line data;

FIG. 11 is a schematic view showing an example of a toner image based on test line data;

FIG. 12 is a schematic view showing an example of output signals from a first resist sensor and a second resist sensor;

FIG. 13 is a flowchart showing the steps of an adjustment indicative value calculation process performed by a sub CPU;

FIG. 14 is a flowchart showing the steps of an adjustment amount generation process performed by an adjustment amount generating section; and

FIG. 15A and FIG. 15B are flowcharts showing the steps of an inclination adjustment process performed by the correcting section.

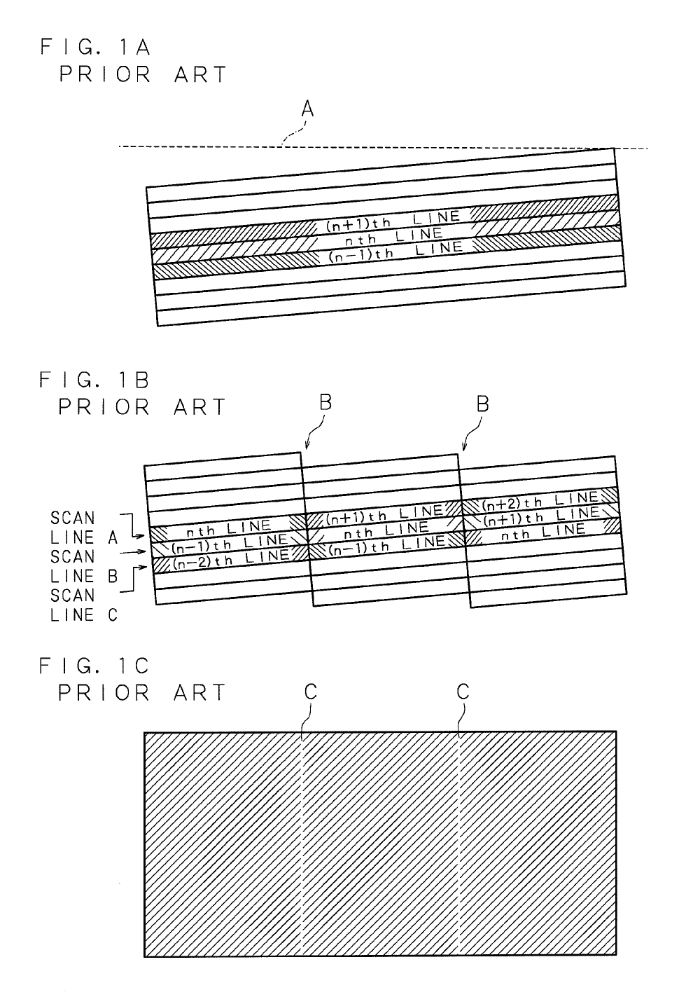

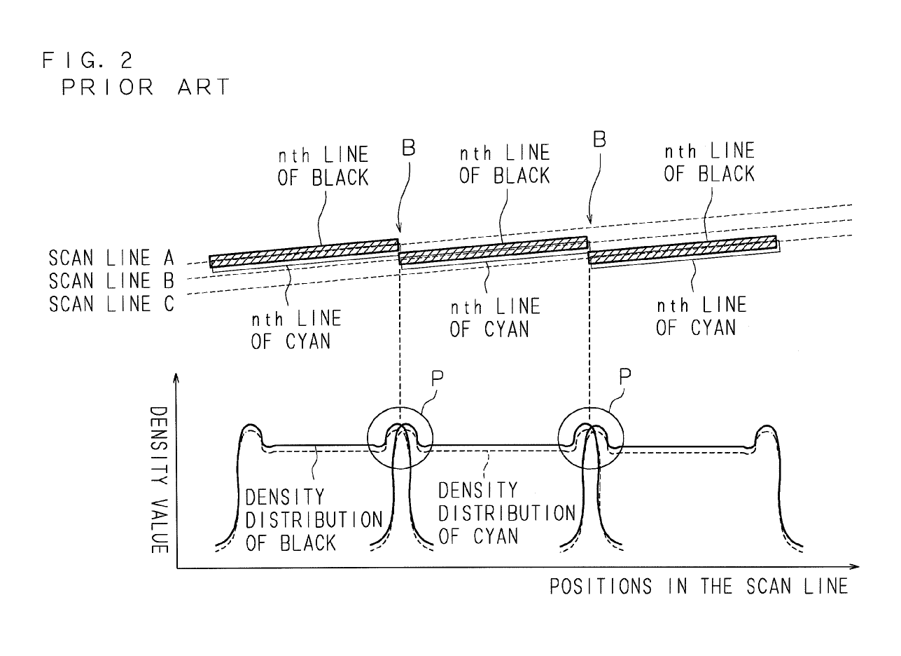

### DETAILED DESCRIPTION

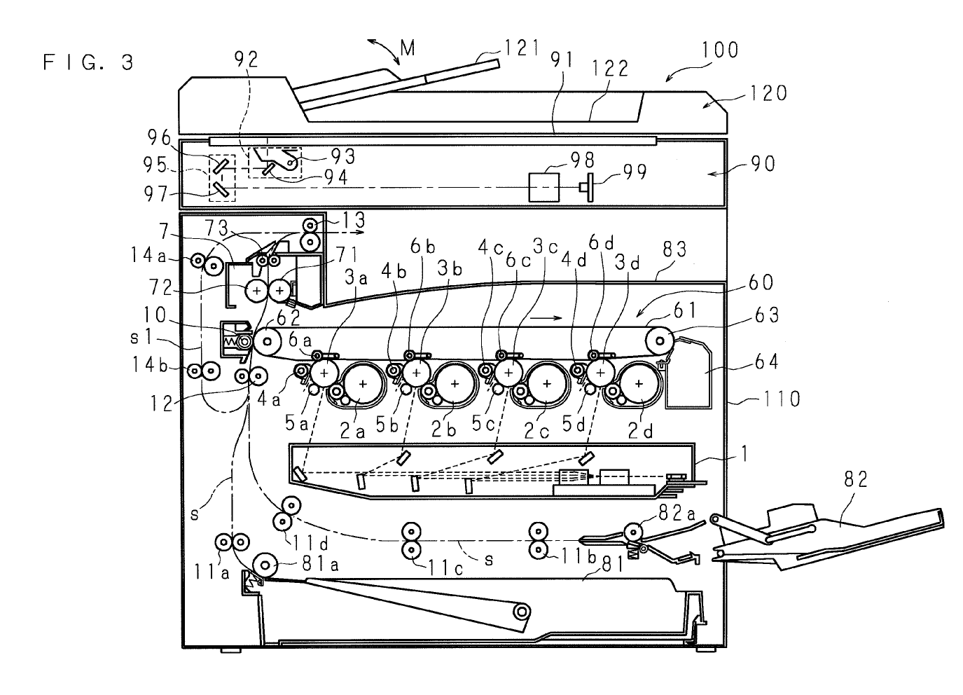

The following description will specifically explain the present invention, based on the drawings illustrating an embodiment thereof. FIG. 3 is a vertical sectional view showing an example of the internal structure of an image forming apparatus according to the present invention. An image forming apparatus 100 according to this embodiment has a scanner function for reading an image on a document; a copy function for forming a multi-color and a mono-color image on a sheet (recording medium) such as copy paper and OHP (Over Head projector) film, based on the read image; and a printer function for forming a multi-color and a mono-color image on a sheet, based on image data from an information processing apparatus (not shown) such as a personal computer connected to an external apparatus.

Provided in the lowest part of the image forming apparatus 100 is a drawer-type paper feed cassette 81 having a tray for storing sheets. A user can open the tray by pulling out the paper feed cassette 81 frontward and can supply sheets in a state in which the tray is opened. In addition, a manual feed tray 82 for loading a small amount of sheets is provided on the right side of the image forming apparatus 100 shown in FIG. 3, and a sheet placed on the manual-feed tray 82 is also taken into the image forming apparatus 100 to form an image thereon.

Provided in the center of the image forming apparatus 100 is an image forming section 110 for forming, on a sheet transported from the paper feed cassette 81 or the manual-feed tray 82, an image based on image data obtained by reading an image on a document or an image based on image data obtained from an external apparatus. Provided on the upper surface of the image forming section 100 is a paper output tray 83 onto which the sheet having the image formed by the image forming section 110 is outputted with the face down.

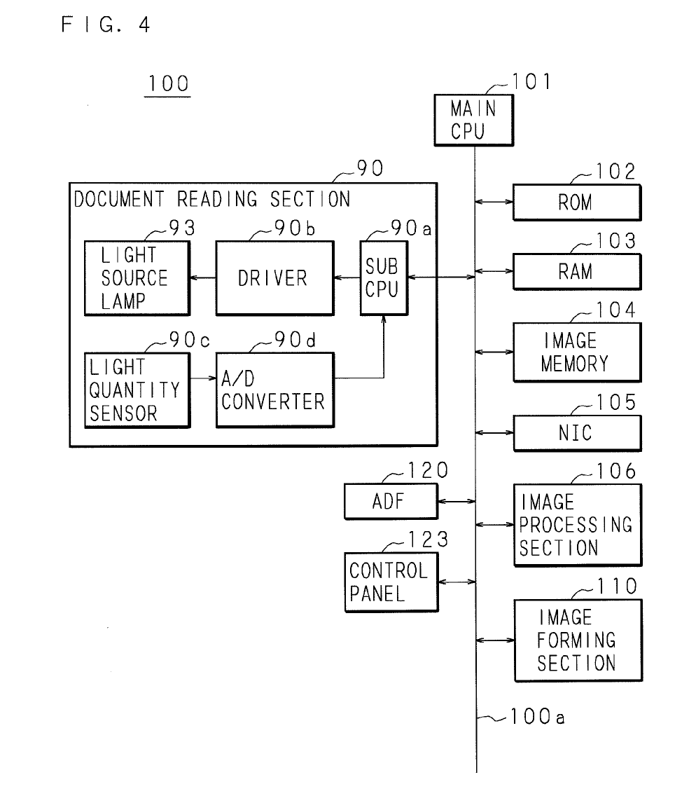

A document reading section 90 is provided above the image forming section 110, and an ADF (Automatic Document Feeder) 120 is provided in the topmost part of the image forming apparatus 100 above the document reading section 90. The ADF 120 separates and fetches one sheet of document at a time from a stack of documents loaded face up on the document tray 121, transports the sheet to a predetermined read position on a platen glass 91 mounted on the upper surface of the document reading section 90, and then outputs the document onto a paper output tray 122. Note that the ADF 120 is mounted so that it is movable in a swinging manner in the direction shown by arrows M with respect to the document reading section 90, and it is possible to place a document on the platen glass 91 by moving the ADF 120 in a swinging manner to open the top of the platen glass 9. Moreover, a control panel 123 (see FIG. 4) for allowing a user to operate the image forming apparatus 100 is provided in the topmost part of the image forming apparatus 100.

The document reading section 90 comprises a light source unit 92, a mirror unit 95, an imaging lens 98, and a CCD (Charge Coupled Device) line sensor 99. The document reading section 90 irradiates reading light from the light source unit 92 onto the front surface of a document transported by the ADF 120 and focuses an optical image from the document onto the CCD line sensor 99 by using the mirror unit 95 and imaging lens 98. Through such processes, the document reading section 90 reads the image recorded on the document surface.

The light source unit 92 condenses illumination light for reading, emitted from a light source lamp 93, onto a suitable read position on the platen glass 91 by a concave reflector, changes the optical path of reflected light from the document by 90° with a mirror 94 mounted with its reflection surface angled at 45° to the surface of the platen glass 91, and guides the light to the mirror unit 95. The mirror unit 95 comprises a pair of mirrors 96 and 97. In order to further change by 180° the optical path of light whose optical path was changed by 90° with the mirror 94 of the light source unit 92, the mirrors 96 and 97 are arranged so that their reflection surfaces cross each other at a right angle.

When reading the document transported by the ADF 120, the document reading section 90 with the above-mentioned structure reads the image while holding the light source unit 92 in a predetermined read position. On the other hand, when reading a document set on the platen glass 91, the document reading section 90 reads the image while scanning the light source unit 92 parallel to the lower surface of the platen glass 91.

The light guided by the mirror unit 95 is focused onto the CCD line sensor 99 by the function of the imaging lens 98. The CCD line sensor 99 converts the inputted light into an analog electric signal corresponding to the light quantity, and outputs the signal. The analog electric signal outputted from the CCD line sensor 99 is converted into a digital signal by an A/D (analog/digital) converter, not shown, corrected for the light distribution characteristics of the light source in reading the document, the variation of sensitivity of the CCD line sensor 99, etc., and generated as image data including a plurality of line data for each of a plurality of color components. The generated image data is outputted and stored in an image memory 104 (see FIG. 4).

The image forming section 110 comprises an exposure unit 1 above the paper feed cassette 81. In order to form a multi-color image using black (BK), cyan (C), magenta (M), and yellow (Y) colors, the image forming section 110 comprises developing devices 2a, 2b, 2c and 2d; photosensitive drums 3a, 3b, 3c and 3d; cleaner units 4a, 4b, 4c and 4d; and electrifiers 5a, 5b, 5c and 5d for the respective colors, above the exposure unit 1.

Although the letters a, b, c and d added to the respective codes are denoted to correspond to black (BK), cyan (C), magenta (M), and yellow (Y), respectively, for example, the members provided for the respective colors will be hereinafter collectively referred to as the developing devices 2, photosensitive drums 3, cleaner units 4, and electrifiers 5, except for the case where the members corresponding to a specific color are specifically explained.

For the electrifiers 5a to 5d, roller-type electrifiers constructed in contact with the corresponding photosensitive drums 3a to 3d are used to evenly charge the surfaces of the photosensitive drums 3a to 3d to a predetermined electric potential. It may be possible to use brush-type electrifiers or charger-type electrifiers, instead of the roller-type electrifiers. The electrifiers 5a to 5d charge the surfaces of the corresponding photosensitive drums 3a to 3d to negative polarity.

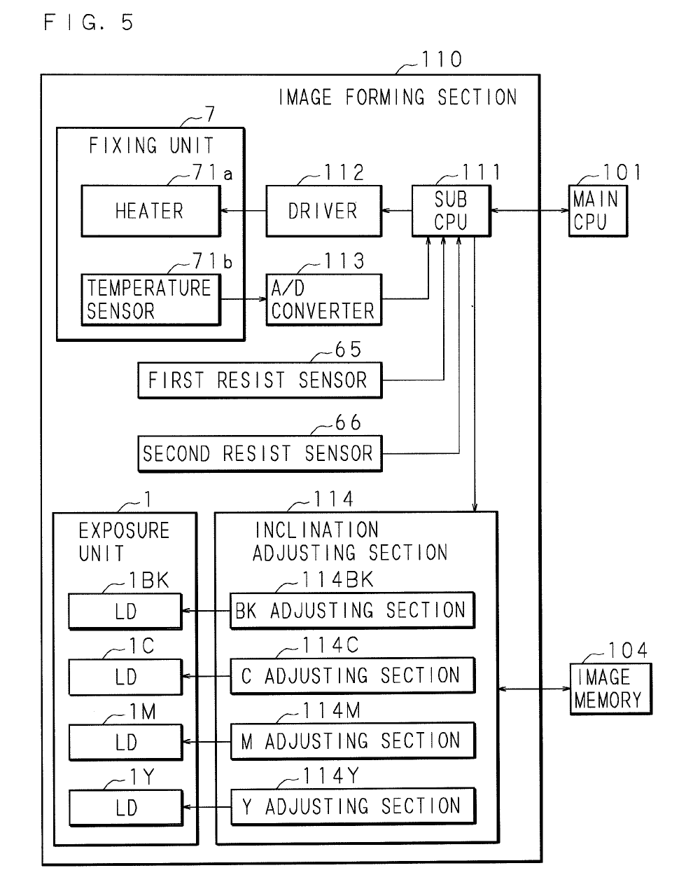

The exposure unit 1 is composed of a laser scanning unit (LSU) including laser diodes 1BK, 1C, 1M, and 1Y (see FIG. 5) for irradiating laser light and reflection mirrors, and comprises a polygon mirror and a reflection mirror so that the laser light emitted from the laser diodes 1BK, 1C, 1M and 1Y is irradiated on the photosensitive drums 3a to 3d. For the exposure unit 1, it is possible to use a write head composed of an array of light emitting elements, such as EL (Electro Luminescence) and LED (Light Emitting Diode), instead of the LSU.

The exposure unit 1 emits laser light, based on image data for printing transferred from the image memory 104, removes the negative charges on the photosensitive drums 3a to 3d by irradiating the laser light on the surfaces of the photosensitive drums 3a to 3d charged by the electrifiers 5a to 5d, and thereby forms electrostatic latent images corresponding to the image data on the photosensitive drums 3a to 3d.

The developing devices 2a to 2d contain black, cyan, magenta, and yellow toners (developers), respectively, charge the contained toners to negative polarity, and supply the toners to the electrostatic latent images formed on the surfaces of the photosensitive drums 3a to 3d. The toner charged to negative polarity adheres to an area of the surface of each of the photosensitive drums 3a to 3d where negative charges are removed by the laser light. Thus, the developing device 2 forms the toner image by visualizing the electrostatic latent image on the corresponding photosensitive drum 3.

In addition to the developing devices 2a to 2d and the electrifiers 5a to 5d, cleaner units 4a to 4d are disposed around the photosensitive drums 3a to 3d. The cleaner units 4a to 4d are provided to collect and remove the toners remaining on the surfaces of the photosensitive drums 3a to 3d after the transfer of the toner images visualized on the surfaces of the photosensitive drums 3a to 3d onto a sheet.

The image forming section 110 of this embodiment is constructed to transfer the toner images on the photosensitive drums 3a to 3d onto a sheet by an intermediate transfer method, and comprises an intermediate transfer unit 60 above the photosensitive drums 3a to 3d. The intermediate transfer unit 60 comprises an intermediate transfer belt 61, an intermediate transfer belt drive roller 62, an intermediate transfer belt driven roller 63, and intermediate transfer rollers 6a, 6b, 6c and 6d. The intermediate transfer rollers 6a, 6b, 6c and 6d will be hereinafter collectively referred to as the intermediate transfer rollers 6.

The intermediate transfer belt drive roller 62, the intermediate transfer belt driven roller 63, and the intermediate transfer rollers 6 are provided so that the intermediate transfer belt 61 is stretched on these rollers and rotated in the direction shown by the arrow in the drawing (sub-scanning direction) by the drive force of the intermediate transfer belt drive roller 62. The intermediate transfer belt driven roller 63 is connected to a power supply section, not shown, and charges the intermediate transfer belt 61 to a predetermined electric potential in the contact section with the intermediate transfer belt 61 by the electric potential from the power supply section thereby attracting the toner images transferred from the respective photosensitive drums 3a to 3d to the intermediate transfer belt 61.

The intermediate transfer belt 61 is formed in an endless form using a film with a thickness of around 100 μm to 150 μm, for example, and mounted so that its surface is in contact with the respective photosensitive drums 3a to 3d. By transferring the toner images in the respective colors formed on the photosensitive drums 3a to 3d successively to the intermediate transfer belt 61 in a superimposed manner, a color toner image (multi-color toner image) is formed on the intermediate transfer belt 61.

The transfer of the toner images from the photosensitive drums 3a to 3d to the intermediate transfer belt 61 is executed by the intermediate transfer rollers 6a to 6d which are in contact with the back side of the intermediate transfer belt 61. In order to transfer the toner images, a high-voltage transfer bias, that is, a high voltage of polarity (+) opposite to the charged polarity (−) of toner, is applied to the intermediate transfer rollers 6a to 6d. The intermediate transfer rollers 6a to 6d are rollers comprising a metal (for example, stainless) shaft with a diameter of 8 mm to 10 mm as a base whose surface is covered with an electrically conductive elastic member such as EPDM and urethane foam. With the electrically conductive elastic member, the intermediate transfer rollers 6a to 6d are cable of evenly applying a high voltage to the intermediate transfer belt 61. In this embodiment, although a roller-like electrode is used as a transfer electrode, it is also possible to use a brush-like electrode.

As descried above, the toner images visualized on the photosensitive drums 3a to 3d according to the respective colors are placed in a superimposed manner on the intermediate transfer belt 61, and an image to be printed is reproduced by the multi-color toner image on the intermediate transfer belt 61. With a rotation of the intermediate transfer belt 61, the multi-color toner image thus transferred onto the intermediate transfer belt 61 is transferred onto a sheet by a transfer roller 10 mounted at the contact section of the sheet and the intermediate transfer belt 61.

At this time, the intermediate transfer belt 61 and the transfer roller 10 are pressed against each other with a predetermined nip, and a voltage for transferring the multi-color toner image onto the sheet, that is, a high voltage of opposite polarity (+) to the charged polarity (−) of toner, is applied to the transfer roller 10. Here in order to constantly obtain a nip between the intermediate transfer belt 61 and the transfer roller 10, either the transfer roller 10 or the intermediate transfer belt drive roller 62 is formed using a hard material such as metal, and the other is formed using a soft material such as a foam resin.

Moreover, the toners adhering to the intermediate transfer belt 61 by the contact with the photosensitive drums 3a to 3d as described above, or the toners remaining on the intermediate transfer belt 61 without being transferred onto the sheet by the transfer roller 10, may cause a mixture of colors of the toners in the following step, and are therefore removed and collected by an intermediate transfer belt cleaning unit 64 provided in the vicinity of the intermediate transfer belt driven roller 63. The intermediate transfer belt cleaning unit 64 is provided with a cleaning blade as a cleaning member that comes into contact with the intermediate transfer belt 61, and the area where the cleaning blade comes into contact with the intermediate transfer belt 61 is supported by the intermediate transfer belt driven roller 63 from the back side of the intermediate transfer belt 61.

The paper feed cassette 81 and the manual feed tray 82 have pick-up rollers 81a and 82a, respectively, in the vicinity of an end of a stack of sheets loaded thereon. A sheet separated and supplied by the pick-up roller 81a or 82a is supplied into the image forming section 110 through a transport path s. A plurality of transport rollers 11a, 11b, 11c, and, 11d are provided at suitable positions on the transport path s, and the sheets separated and supplied to the transport rollers 11a and 11b by the respective pick-up rollers 81a and 82 are transported through the transport paths s to resist rollers 12 by the transport rollers 11a, 11b, 11c and 11d.

The resist rollers 12 are provided under the above-described transfer roller 10 and intermediate transfer belt drive roller 62. By operating the resist rollers 12 to transport the sheet to the transfer roller 10 at the timing at which an end of the sheet transported from the paper feed cassette 81 or the manual feed tray 82 matches an end of the toner image on the intermediate transfer belt 61, the toner image on the intermediate transfer belt 61 is transferred onto the sheet.

The sheet to which the toner image has been transferred is transported substantially vertically and reaches a fixing unit 7 provided above the transfer roller 10. The fixing unit 7 comprises a heat roller 71 and a pressure roller 72, and keeps the heat roller 71 at a predetermined fixing temperature by controlling a heater 71a (see FIG. 5) based on the value detected by a temperature sensor 71b (see FIG. 5). Moreover, the fixing unit 7 turns the sheet having the transferred multi-color toner image thereon by holding the sheet between the heat roller 71 and the pressure roller 72 and thermally fixes the multi-color toner image onto the sheet by the heat of the heat roller 71. After the thermal fixation, the sheet is outputted by transport rollers 73 provided in the vicinity of the outlet of the fixing unit 7.

When single-side printing is requested, the sheet which has passed through the fixing unit 7 is outputted face down onto the paper output tray 83 through a paper output roller 13. When double-side printing is requested, the sheet is temporarily chucked by the paper output roller 13 and then guided to a double-side document transport path S1 with a reverse rotation of the paper output roller 13, and transported to the resist roller 12 again by transport rollers 14a and 14b. After transferring and thermally fixing the toner image onto the back side of the sheet, the sheet is outputted onto the paper output tray 83 by the paper output roller 13.

In addition to the above-mentioned structure, the image forming apparatus 100 may comprise, for example, a paper feed cassette capable of storing a plurality of types of sheets of different sizes, a large-capacity paper feed Cassette capable of storing several thousands sheets, a plurality of paper output trays, and a transport mechanism for transporting sheets having images formed thereon to the respective paper output trays. It is also possible to attach these members later as optional functions to the image forming apparatus 100.

FIG. 4 is a block diagram showing an example of the structure of the control system of the image forming apparatus 100 according to the present invention. The image forming apparatus 100 comprises a main CPU 101. Connected through a bus 100a to the main CPU 101 are various kinds of hardware units, such as a ROM 102, a RAM 103, an image memory 104, an NIC (Network Interface Card) 105, an image processing section 106, a document reading section 90, an image forming section 110, an ADF 120, and a control panel 123. Further, the image forming apparatus 100 comprises a power source device, not shown, to activate the above-described hardware units by the power supplied from the power source device.

The ROM 102 stores, in advance, a control program for enabling the main CPU 101 to control the above-described hardware units. The RAM 103 is a non-volatile semiconductor memory and temporarily stores data generated when the main CPU 101 is executing the control program. By reading the control program stored in the ROM 102 into the RAM 103 and successively executing the program by the main CPU 101, it is possible to control the image forming apparatus 100 to operate as the image processing apparatus and image forming apparatus of the present invention.

The image memory 104 is a non-volatile semiconductor memory and a page memory for temporarily storing image data read from a document by the document reading section 90, image data for printing obtained by developing a print job received from an external device through the NIC 105, and image data on which predetermined image processing has been performed by the image processing section 106. The image data stored in the image memory 104 is read into the image forming section 110 at the timing specified by the main CPU 101, and then sent to the exposure unit 1 of the image forming section 110.

The NIC 105 is a communication interface for communicating with an information processing apparatus, such as an external personal computer, through a communication network, receives a print job transferred from the external information processing apparatus, and transmits information to be reported to the information processing apparatus. The NIC 105 transfers the received print job to the information processing section 106, and then the image processing section 106 generates image data by developing the print job. The image data generated by the image processing section 106 is stored in the image memory 104.

The control panel 123 comprises a control section including various types of control buttons for receiving control instructions from a user; and a display section, such as an LED display and a liquid crystal display, for displaying the information to be reported to the user. The control panel 123 may be composed of a touch panel capable of providing input by touching the display screen.

With the above-mentioned structure, the image forming apparatus 100 of this embodiment is capable of forming an image based on image data read from a document which is read by the document reading section 90, or an image based on image data received from an external information processing apparatus through the NIC 105, on a sheet by the image forming section 110.

In addition to the above-mentioned structure, the document reading section 90 comprises a sub CPU 90a for controlling hardware units constituting the document reading section 90 according to control from the main CPU 101; a driver 90b for driving the light source lamp 93; a light quantity sensor 90c; and an A/D converter 90d. The driver 90b turns on/off the light source lamp 93 according to control from the sub CPU 90a. The light quantity sensor 90c detects the light quantity of light irradiated by the light source lamp 93, and the A/D converter 90d converts the light quantity detected by the light quantity sensor 90c into digital light quantity data and sends the obtained light quantity data to the sub CPU 90a.

When the image forming apparatus 100 is activated, the main CPU 101 transmits a predetermined warm-up command to the sub CPU 90a of the document reading section 90. When the sub CPU 90a obtains the predetermined warm-up command from the main CPU 101, the driver 90b starts to supply power to the light source lamp 93. The supply of power to the light source lamp 93 by the driver 90b is controlled by the sub CPU 90c based on the light quantity data obtained by the light quantity sensor 90c and the A/D converter 90d, so that the light quantity of the light source lamp 93 is fixed at predetermined quantity. When the light quantity of the light source lamp 93 reaches the predetermined light quantity, the sub CPU 90a determines that it has reached a processing available state (ready state) and reports this state to the main CPU 101. Thus, the main CPU 101 knows that it is possible to execute the document reading process by the document reading section 90.

In addition to the above-mentioned devices, a large number of input and output devices to be operated during the document reading process, such as a motor, a clutch, a solenoid, and a sensor in the document reading section 90, are connected to the sub CPU 90a. The sub CPU 90a reads data detected by the sensor at predetermined timing during the document reading process, and drives the motor according to the detected data.

FIG. 5 is a block diagram showing an example of the structure of the control system of the image forming section 110. In addition to the above-mentioned structure, the image forming section 110 comprises a sub CPU 111 for controlling hardware units constituting the image forming section 110 according to control from the main CPU 101; a driver 112 for driving the heater 71a of the fixing unit 7; and an A/D converter 113 for converting the temperature detected by the temperature sensor 71b into digital temperature data.

The driver 112 drives the heater 71a according to control from the sub CPU 111. The temperature sensor 71b detects the temperature of the heat roller 71 heated by the heater 71a, and the A/D converter 113 converts the temperature detected by the temperature sensor 71b into temperature data and transmits the temperature data to the sub CPU 111.

When the image forming apparatus 100 is activated, the main CPU 101 transmits a predetermined warm-up command to the sub CPU 111 of the image forming section 110. When the sub CPU 111 obtains the predetermined warm-up command from the main CPU 101, the driver 112 starts supplying power to the heater 71a. The supply of power to the heater 71a by the driver 112 is controlled based on the temperature data obtained by the temperature sensor 71b and the A/D converter 113, so that the surface temperature of the heat roller 71 heated by the heater 71a is fixed at a predetermined temperature. When the surface temperature of the heat roller 71 reaches the predetermined temperature, the sub CPU 111 determines that it has reached a processing available state (ready state) and reports this state to the main CPU 101. Thus, the main CPU 101 knows that it is possible to execute the image formation process by the image forming section 110.

Moreover, the image forming section 110 comprises a first resist sensor 65, a second resist sensor 66, and an inclination adjusting section 114. The first resist sensor 65 and second resist sensor 66 are optical sensors and detect the position of the toner image transferred onto the intermediate transfer belt 61. More specifically, the first resist sensor 65 and the second resist sensor 66 are provided in the vicinity of both ends in a direction (main scanning direction) orthogonal to the rotation direction (sub-scanning direction) of the intermediate transfer belt 61, at any position between the contact surface of the intermediate transfer belt 61 with the photosensitive drum 3a and the contact surface of the intermediate transfer belt 61 with the transfer roller 10, detect the positions of both ends on a single scan line in the toner image transferred onto the intermediate transfer belt 61, and report the detected positions to the sub CPU 111.

Here, suppose that the first resist sensor 65 is provided on the front side of the image forming apparatus 100 shown in FIG. 3 and the second resist sensor 66 is provided on the rear side of the image forming apparatus 100 in FIG. 3. Hence, the first resist sensor 65 detects a position on the front side on a single scan line in the toner image transferred onto the intermediate transfer belt 61, and the second resist sensor 66 detects a position on the rear side on the same scan line in the toner image transferred onto the intermediate transfer belt 61.

The inclination adjusting section 114 is a circuit for performing the process of adjusting an inclination of an image with respect to image data transferred from the image memory 104 to form an image by the image forming section 110, and comprises a BK adjusting section 114BK, a C adjusting section 114C, an M adjusting section 114M, and a Y adjusting section 114Y for the respective colors. The sub CPU 111 calculates, based on the information reported from the first resist sensor 65 and the second resist sensor 66, inclinations of the toner images of the respective colors formed on the photosensitive drums 3a to 3d, and transmits adjustment indicative values indicating the calculated inclinations to the respective adjusting sections 114BK, 114C, 114M and 114Y of the inclination adjusting section 114.

The adjustment indicative value is information indicating which direction and how many dots each scan line in the toner images of the respective colors formed on the photosensitive drums 3a to 3d is inclined, and specifies an inclination to be corrected by each adjusting section 114BK, 114C, 114M, 114Y of the inclination adjusting section 114. More specifically, the adjustment indicative value is information indicating how many dots one end of each scan line is displaced frontward or backward in the sub-scanning direction with respect to the other end. Hence, the adjusting sections 114BK, 114C, 114M and 114Y of the inclination adjusting section 114 generate, based on the adjustment indicative values obtained from the sub CPU 111, adjustment amounts for the inclination adjustment process to be performed by themselves, execute the inclination adjustment process based on the generated adjustment amounts on the image data obtained from the image memory 104, and transmit the image data of the respective colors after the inclination adjustment to the respective laser diodes (hereinafter referred to as “LD”) 1BK, 1C, 1M, and 1Y of the exposure unit 1.

Note that the sub CPU 111 not only calculates the inclinations of the toner images of the respective colors, but may also calculate adjustment amounts for the inclination adjustment process to be performed based on the calculated inclinations by the inclination adjusting section 114 and transmit the adjustment amounts to the respective adjusting sections 114BK, 114C, 114M and 114Y of the inclination adjusting section 114. In this case, the adjusting sections 114BK, 114C, 114M and 114Y of the inclination adjusting section 114 may perform the inclination adjustment process using the adjustment amounts obtained from the sub CPU 111 as they are on the image data obtained from the image memory 104.

Thus, by performing the predetermined inclination adjustment process on the image data, it is possible to reduce inclinations with respect to the main scanning direction, which occur in the toner images formed on the surface of the intermediate transfer belt 61 due to displacements of the installation angles of the exposure unit 1, photosensitive drums 3, intermediate transfer unit 60 etc. Accordingly, it is possible to reduce out-of-color registration and form a good-quality image on a sheet, based on the toner images formed on the surface of the intermediate transfer belt 61 by reducing the inclinations with respect to the main scanning direction.

In addition to the above-mentioned devices, a large number of input and output devices to be operated during the image formation process, such as a motor, a clutch, a solenoid, and a sensor in the image formation section 110, are connected to the sub CPU 111 of the image forming apparatus 100. The sub CPU 111 reads the data detected by the sensor at predetermined timing and drives the motor etc. according to the detected data during the image formation process.

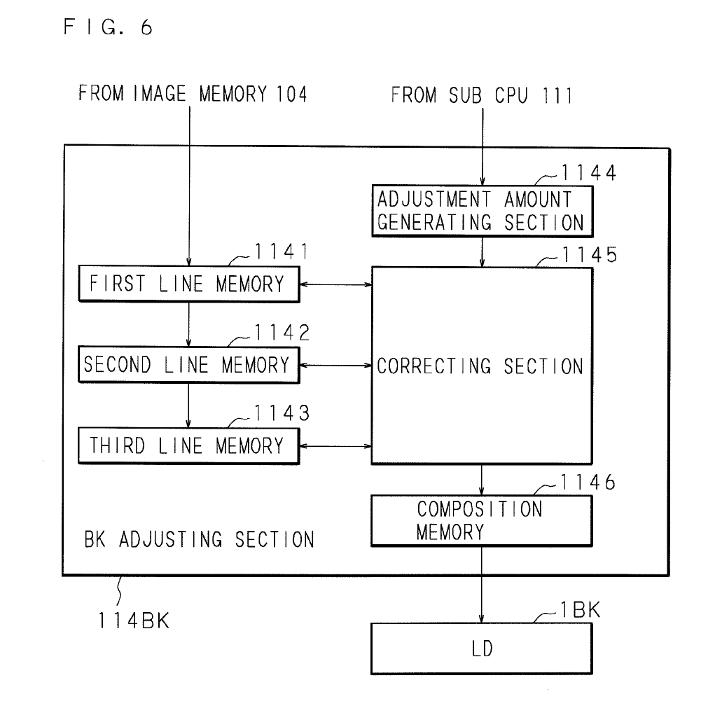

The following will explain specifically the inclination adjustment process performed by the inclination adjusting section 114. FIG. 6 is a block diagram showing an example of the structure of the control system of the inclination adjusting section 114. Although only the structure of the BK adjusting section 114BK is illustrated in FIG. 6, the C adjusting section 114C, the M adjusting section 114M and the Y adjusting section 114Y have the same structure.

The BK adjusting section 114BK comprises a first line memory 1141, a second line memory 1142, a third line memory 1143, an adjustment amount generating section 1144, a correcting section 1145, and a composition memory 1146. The main CPU 101 of the image forming apparatus 100 successively reads the image data stored in the image memory 104 and serially transfers the image data to the inclination adjusting section 114 of the image forming section 110.

Each of the first line memory 1141, second line memory 1142 and third line memory 1143 is an FIFO (First-In First-Out) memory for storing image data of one line (line data) in the main scanning direction in the image data. The first line memory 1141 successively stores black line data in the image data serially transferred from the image memory 104; the second line memory 1142 successively stores the line data shift-transferred from the first line memory 1141; and the third line memory 1143 successively stores the line data shift-transferred from the second line memory 1142.

The correcting section 1145 generates, based on the line data stored in the respective first line memory 1141, second line memory 1142 and third line memory 1143, line data after adjustment (inclination adjustment), and transmits the data to the composition memory 1146. More specifically, the correcting section 1145 specifies addresses for the first line memory 1141, the second line memory 1142, and the third line memory 1143, respectively, and makes a request to read the data stored in the specified addresses. The first line memory 1141, the second line memory 1142, and the third line memory 1143 transmit the data stored in the addresses specified by the correcting section 1145 to the correcting section 1145.

The correcting section 1145 combines the data obtained from the respective first line memory 1141, second line memory 1142 and third line memory 1143, and stores the resulting data in the composition memory 1146. The composition memory 1146 outputs the line data after the inclination adjustment process, which was obtained from the correcting section 1145 and stored, to the LD 1BK of the exposure unit 1. Accordingly, when the LD 1BK irradiates laser light based on the image data obtained from the composition memory 1146, it is possible to form an electrostatic latent image with corrected inclination on the surface of the photosensitive drum 3.

In the line data stored in the first memory 1141, the second line memory 1142 and the third line memory 1143, the correcting section 1145 determines, based on an adjustment amount obtained from the adjustment amount generating section 1144, which data stored at which address in the line memories 1141, 1142 and 1143 should be read. The adjustment amount generating section 1144 has obtained an adjustment indicative value from the sub CPU 111, and generates an adjustment amount based on the obtained adjustment indicative value. The adjustment indicative value calculation process performed by the sub CPU 111 and the adjustment amount generation process performed by the adjustment amount generating section 1144 will be described in detail later.

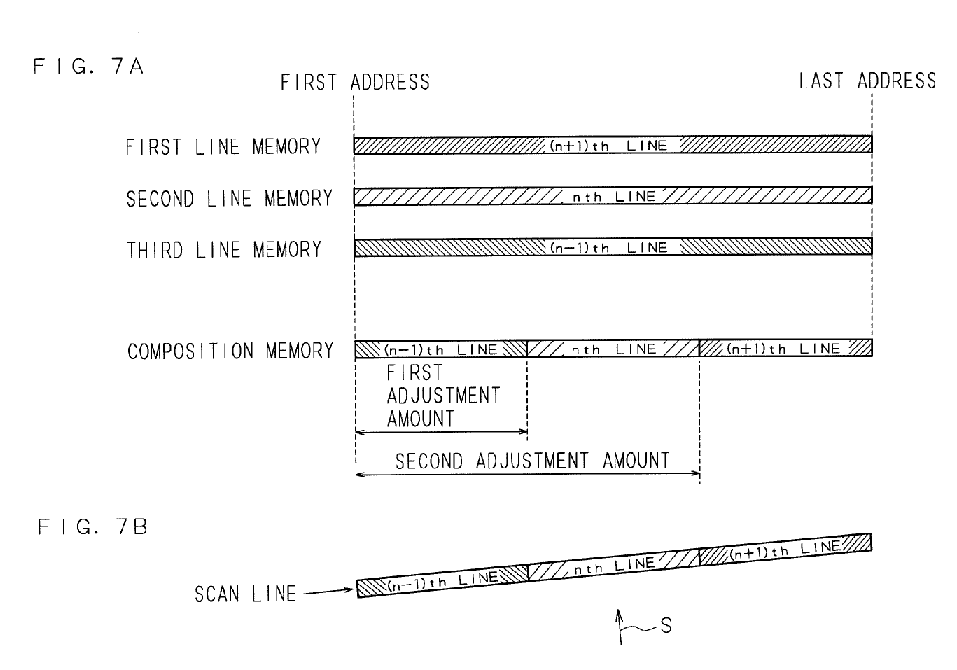

FIG. 7A and FIG. 7B are explanatory views for explaining the inclination adjustment process performed by the correcting section 1145. The following will explain the inclination adjustment process performed when each scan line in the toner image formed on the surface of the intermediate transfer belt 61 is inclined upward to the right with respect to the moving direction S of the intermediate transfer belt 61 as shown in FIG. 7B. The following will also explain the process performed by the correcting section 1145 in a state in which line data on the (n+1)th line in the image data transferred from the image memory 104 is stored in the first line memory 1141, line data on the nth line is stored in the second line memory 1142, and line data on the (n−1)th line is stored in the third line memory 1143 as shown in FIG. 7A.

When the correcting section 1145 obtains two adjustment amounts, namely the first adjustment amount and the second adjustment amount (first adjustment amount<second adjustment amount), from the adjustment amount generating section 1144, it gives an instruction for the third line memory 1143 to read data from the first address to an address obtained by adding the first adjustment amount to the first address; an instruction for the second line memory 1142 to read data from an address obtained by adding the first adjustment amount to the first address to an address obtained by adding the second adjustment amount to the first address; and an instruction for the first line memory 1411 to read data from an address obtained by adding the second adjustment amount to the first address to the last address.

The correcting section 1145 combines the data obtained from the first line memory 1141, the second line memory 1142, and the third line memory 1143 to generate line data in which, as shown in FIG. 7A, data from the first address to the first adjustment amount is the data on the (n−1)th line; data from the first adjustment amount to the second adjustment amount is the data on the nth line; and data from the second adjustment amount to the last address is the data on the (n+1)th line, and stores the line data in the composition memory 1146.

With the above-described inclination adjustment process, as shown in FIG. 7B, even when the toner image formed on the surface of the intermediate transfer belt 61 is inclined upward to the right with respect to the moving direction S of the intermediate transfer belt 61 due to displacements of the installation angles of the exposure unit 1, photosensitive drum 3, intermediate transfer unit 60 etc., it is possible to form the toner image without inclination on the surface of the intermediate transfer belt 61.

Thus, the correcting section 1145 operates as segmenting means for dividing each line data into a plurality of segments at the position of an address obtained by adding the first adjustment amount to the first address and the position of an address obtained by adding the second adjustment amount to the first address, and also operates as correcting means for performing the process of correcting an inclination for each segment. Since the correcting section 1145 determines addresses of data to be read from the respective line memories 1141, 1142 and 1143, based on the adjustment amounts obtained from the adjustment amount generating section 1144, the adjustment amount generating section 1144 operates as setting means for setting positions for the correcting section 1145 to divide each line data for each color component.

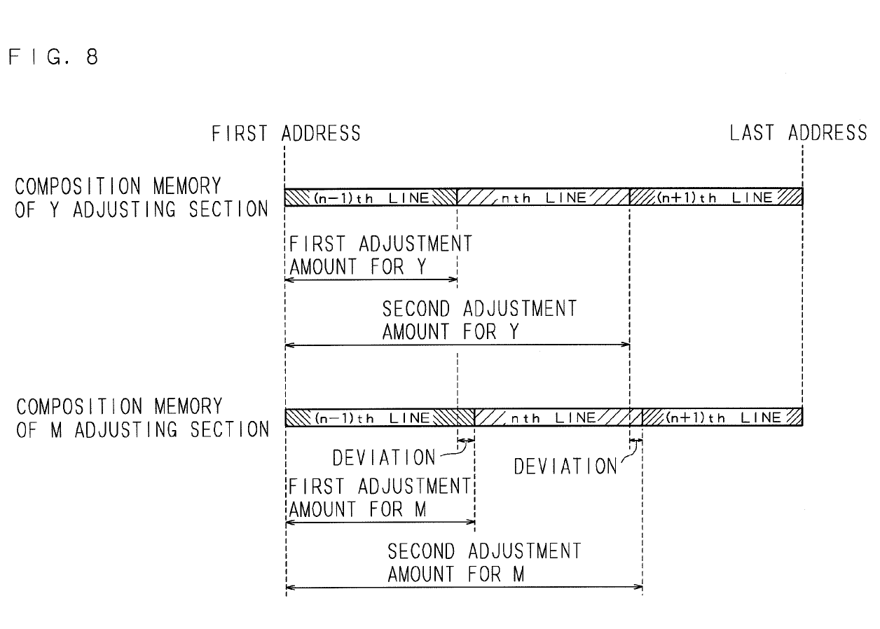

FIG. 8 is an explanatory view for explaining the inclination adjustment process performed by the inclination adjusting section 114. FIG. 8 shows line data corrected by the correcting section of the Y adjusting section 114Y and stored in the composition memory, and line data corrected by the correcting section of the M adjusting section 114M and stored in the composition memory. In this embodiment, since the BK adjusting section 114BK, C adjusting section 114C, M adjusting section 114M and Y adjusting section 114Y of the inclination adjusting section 114 obtain mutually different adjustment indicative values from the sub CPU 111, the adjustment amounts (first adjustment amount and second adjustment amount) generated by the adjustment amount generating sections 1144 of these BK adjusting section 114BK, C adjusting section 114C, M adjusting section 114M and Y adjusting section 114Y are also different from each other.

Note that the BK adjusting section 114BK, C adjusting section 114C, M adjusting section 114M and Y adjusting section 114Y of the inclination adjusting section 114 may obtain the same adjustment indicative value from the sub CPU 111. However, since mutually different predetermined numerical values are stored in the memories (not shown) of the BK adjusting section 114BK, C adjusting section 114C, M adjusting section 114M and Y adjusting section 114Y, even when the adjustment amounts are generated based on the same adjustment indicative value, it is possible to generate different adjustment amounts based on the numerical values stored in the respective memories.

Thus, since the first adjustment amount and the second adjustment amount for Y generated by the adjustment amount generating section of the Y adjusting section 114Y are different from the first adjustment amount and the second adjustment amount for M generated by the adjustment amount generating section of the M adjusting section 114M, as shown in FIG. 8, there are deviations in the position of dividing the data on the (n−1)th line and the data on the nth line before correction and the position of dividing the data on the nth line and the data on the (n+1)th line before correction between the line data stored in the composition memory of the Y adjusting section 114Y and the line data stored in the composition memory of the M adjusting section M. Hence, the positions of the gaps caused by the density difference between the line data on the (n−1)th and the data on the nth line before correction and the density difference between the data on the nth line and the data on the (n+1)th line before correction can be varied for each color component.

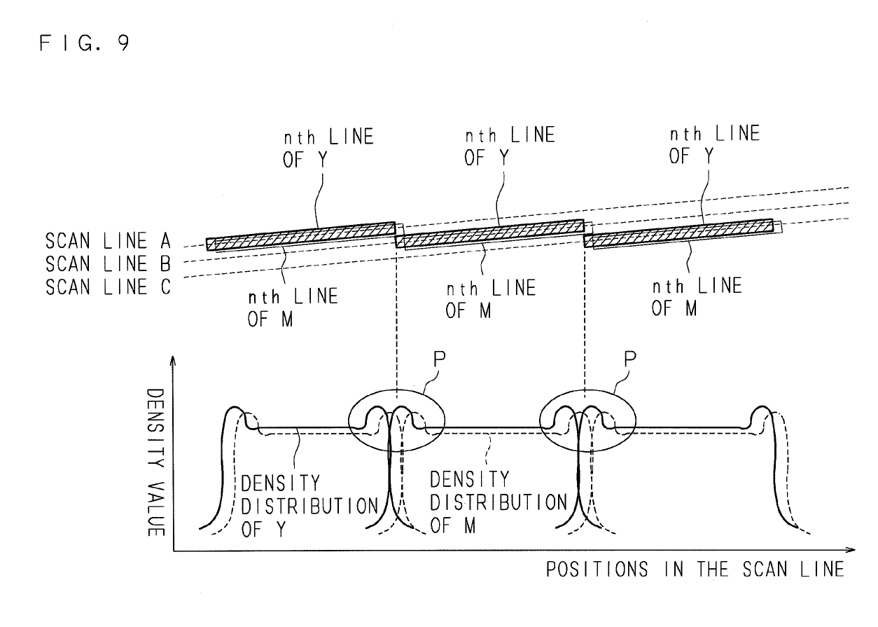

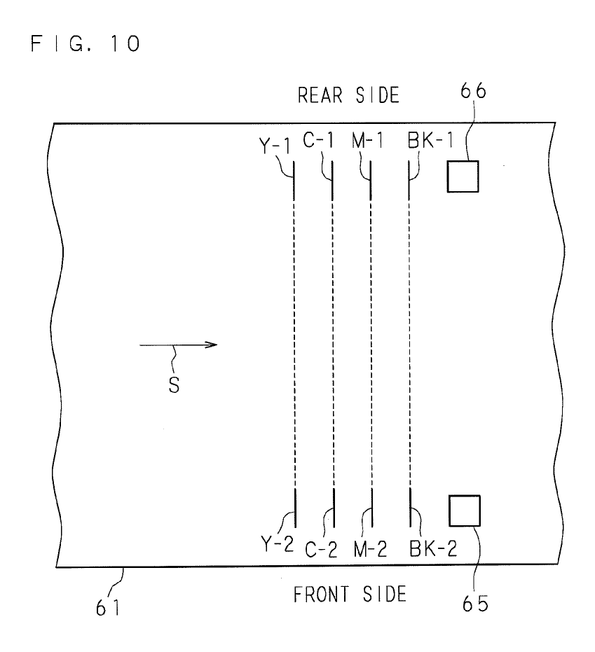

FIG. 9 is an explanatory view for explaining the inclination adjustment process performed by the inclination adjusting section 114. FIG. 9 shows part of the scan lines A, B and C in the toner image formed based on the line data of Y component and the line data of M component shown in FIG. 8 on the surface of the intermediate transfer belt 61 by the image forming section 110, and also shows an example of the density distributions of Y component and M component in each pixel on the scan line A.

As described above, even when there are gaps in the image data of each color component the positions of the gaps can be varied among the respective color components, and therefore it is possible to scatter the density peaks P and P of the respective color components as shown in FIG. 9. Consequently, the lines caused by the density peaks P and P and running in the sub-scanning direction can be made less noticeable, and it is possible to form a good-quality image based on such image data of the respective color components.

The following will explain the adjustment indicative value calculation process performed by the sub CPU 111 and the adjustment amount generation process performed by the adjustment amount generating section 1144. First, the adjustment indicative value calculation process performed by the sub CPU 111 will be explained. When a user or a service person sets the image forming apparatus 100 in a test mode through the control panel 123, the sub CPU 111 of the image forming apparatus 110 starts to perform the adjustment indicative value calculation process according to an instruction from the main CPU 101.

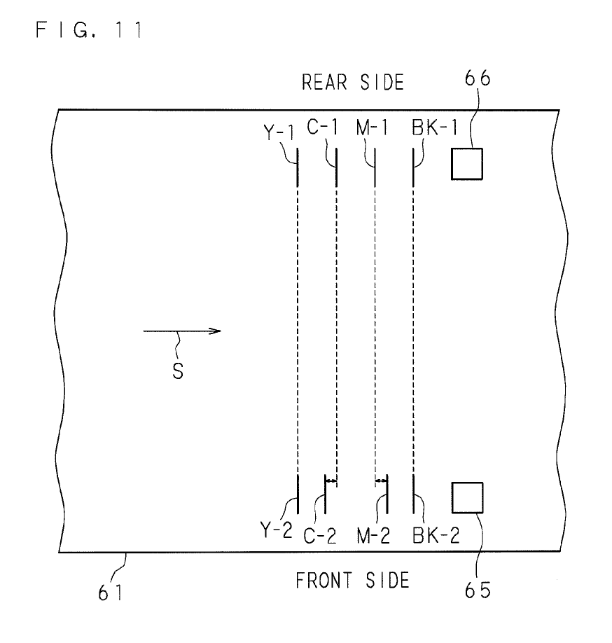

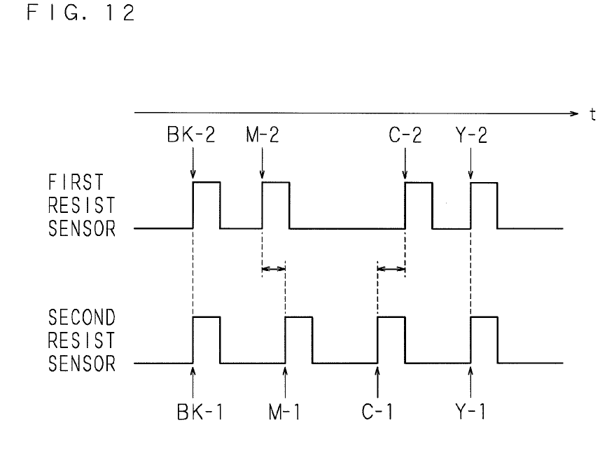

When the hardware units are ready to execute the image formation process by starting to supply power to the respective hardware units, such as the exposure unit 1 and fixing unit 7, the sub CPU 111 inputs test line data stored in a memory, not shown, or the image memory 104, into the exposure unit 1, and forms toner images based on the line data on the surface of the intermediate transfer belt 61. FIG. 10 and FIG. 11 are schematic views showing examples of the toner images based on the test line data. FIG. 10 shows toner images without inclination, and FIG. 11 shows toner images which are inclined.

The toner images shown in FIG. 10 and FIG. 11 are toner images based on the test line data, the black toner image indicated by BK-1 and BK-2 is an image on a single scan line, the magenta toner image indicated by M-1 and M-2 is an image on a single scan line, the cyan toner image indicated by C-1 and C-2 is an image on a single scan line, and the yellow toner image indicated by Y-1 and Y-2 is an image on a single scan line.

As shown in FIG. 10 and FIG. 11, with the movement of the intermediate transfer roller 61 in the moving direction S, the first resist sensor 65 and second resist sensor 66 detect simultaneously both end portions of the toner image on a single line formed on the intermediate transfer belt 61. Therefore, as shown in FIG. 10, when the toner image formed on the intermediate transfer belt 61 is not inclined, the first resist sensor 65 and the second resist sensor 66 can simultaneously detect the toner image of the same color component.

On the other hand, as shown in FIG. 11, when the toner image formed on the intermediate transfer belt 61 is inclined, the first resist sensor 65 and the second resist sensor 66 can not detect the toner image of the same color component simultaneously, and the first resist sensor 65 and the second resist sensor 66 detect the toner image of the same color component at different timings. Note that FIG. 11 shows an example in which the magenta and cyan toner images are inclined.

The first resist sensor 65 and the second resist sensor 66 detect the toner images formed on the intermediate transfer belt 61 and transmit output signals to the sub CPU 111. Then, the sub CPU 111 calculates, based on the output signals, adjustment indicative values to be inputted to the respective adjusting sections 114BK, 114C, 114M and 114Y of the inclination adjusting section 114.

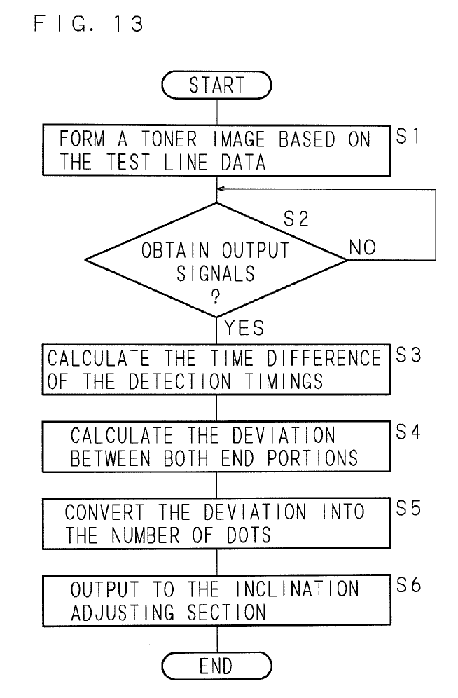

FIG. 12 is a schematic view showing an example of the output signals from the first resist sensor 65 and the second resist sensor 66 with the horizontal axis as the time axis, and shows the output signals of the first resist sensor 65 and the second resist sensor 66 when the toner images shown in FIG. 11 were detected. As shown in FIG. 12, the first resist sensor 65 successively detects the black toner image BK-2, magenta toner image M-2, cyan toner image C-2, and yellow toner image Y-2 shown in FIG. 11, while the second resist sensor 66 successively detects the black toner image BK-1, magenta toner image M-1, cyan toner image C-1, and yellow toner image Y-1 shown in FIG. 11.

Here, since the magenta and cyan toner images shown in FIG. 11 are inclined, there is a time difference between the timing that the first resist sensor 65 detects the magenta toner image M-2 and cyan toner image C-2 and the timing that the second resist sensor 66 detects the magenta toner image M-1 and the cyan toner image C-1 shown in FIG. 12.

The sub CPU 111 calculates a distance (deviation) in the sub-scanning direction between both end portions of the toner image based on the test line data by multiplying the time difference in the timings the first resist sensor 65 and the second resist sensor 66 detect the toner image of the same color component by the moving speed of the intermediate transfer belt 61. When the detection timing of the first resist sensor 65 is earlier than the detection timing of the second resist sensor 66, the toner image is inclined upward to the right with respect to the moving direction S of the intermediate transfer belt 61 as the upward direction, whereas when the detection timing of the first resist sensor 65 is later than the detection timing of the second resist sensor 66, the toner image is inclined downward to the right with respect to the moving direction S of the intermediate transfer belt 61 as the upward direction.

Then, the sub CPU 111 calculates the deviation (inclined direction and inclined amount), in the sub-scanning direction, between both end portions of the toner image based on the test line data by multiplying the time difference of the detection timing of the first resist sensor 65 from the detection timing of the second resist sensor 66 as a reference, that is, the time difference indicated by a negative value when the detection timing of the first resist sensor 65 is earlier than the detection timing of the second resist sensor 66, or the time difference indicated by a positive value when the detection timing of the first resist sensor 65 is later than the detection timing of the second resist sensor 66, by the moving speed of the intermediate transfer belt 61. Here, if the calculated deviation is a positive value, the toner image is inclined downward to the right with respect to the moving direction S of the intermediate transfer belt 61 as the upward direction, whereas if the calculated deviation is a negative value, the toner image is inclined upward to the right with respect to the moving direction S of the intermediate transfer belt 61 as the upward direction.

The sub CPU 111 divides the calculated deviation by the diameter of a dot formed by the image forming section 110 so as to convert the deviation in the sub-scanning direction between both end portions of the toner image based on the test line data into the number of dots. The number of dots thus calculated is an adjustment indicative value indicating an inclination to be corrected by the inclination adjusting section 114. When the calculated number of dots (adjustment indicative value) is a negative value, the toner image is inclined upward to the right with respect to the moving direction S of the intermediate transfer belt 61 as the upward direction, whereas when the calculated number of dots is a positive value, the toner image is inclined downward to the right with respect to the moving direction S of the intermediate transfer belt 61 as the upward direction. Further, the sub CPU 111 calculates such an adjustment indicative value for each of the color components, and inputs the adjustment indicative values to the respective inclination adjusting sections 114BK, 114C, 114M and 114Y of the inclination adjusting section 114.

Since the first resist sensor 65 and the second resist sensor 66 detect only both end portions of the toner image on a single scan line, line data having 0 for pixel values except for both end portions may be used for the test line data shown in FIG. 10 and FIG. 11. However, the test line data is not necessarily limited to this, and it is possible to use appropriate line data according to the installation positions of the first resist sensor 65 and the second resist sensor 66.

Next, the following will explain the adjustment amount generation process performed by the adjustment amount generating sections 1144 of the respective adjusting sections 114BK, 114C, 114M and 114Y of the inclination adjusting section 114, based on the adjustment indicative values calculated by the sub CPU 111 as described above. When the adjustment indicative values calculated as described above are obtained from the sub CPU 111, the adjustment amount generating sections 1144 in the respective adjusting sections 114BK, 114C, 114M and 114Y of the inclination adjusting section 114 generate adjustment amounts for use in the inclination adjustment process performed by the correcting section 1145.

First, when the adjustment indicative value calculated by the sub CPU 111 is 0, the toner image formed on the intermediate transfer belt 61 is not inclined, and therefore the respective adjusting sections 114BK, 114C, 114M and 114Y of the inclination adjusting section 114 do nothing and output the image data transferred from the image memory 104 to the LDs 1BK, 1C, 1M and 1Y of the exposure unit 1. At this time, the adjustment amount generating sections 1144 of the respective adjusting sections 114BK, 114C, 114M and 114Y store 0 as the adjustment amount in the memories (not shown), and output the adjustment amount to the correcting section 1145 when the correcting section 1145 performs the inclination adjustment process.

If the adjustment indicative value calculated by the sub CPU 111 is not 0, for example, is a positive value, then the toner image formed on the intermediate transfer belt 61 is inclined downward to the right with respect to the moving direction S of the intermediate transfer belt 61 as the upward direction, and there is a deviation of |adjustment indicative value| (the absolute value of the adjustment indicative value) dots between the left and right ends. Therefore, the respective adjusting sections 114BK, 114C, 114M and 114Y of the inclination adjusting section 114 perform the inclination adjustment process on the image data transferred from the image memory 104 so as to correct and incline the image upward to the right, and then output the image data to the LDs 1BK, 1C, 1M and 1Y of the exposure unit 1.

On the other hand, when the adjustment indicative value is a negative value, the toner image formed on the intermediate transfer belt 61 is inclined upward to the right with respect to the moving direction S of the intermediate transfer belt 61 as the upward direction, and there is a deviation of |adjustment indicative value| (the absolute value of the adjustment indicative value) dots between the left and right ends. Therefore, the respective adjusting sections 114BK, 114C, 114M and 114Y of the inclination adjusting section 114 perform the inclination adjustment process on the image data transferred from the image memory 104 so as to correct and incline the image downward to the right, and then output the image data to the LDs 1BK, 1C, 1M and 1Y of the exposure unit 1.

More specifically, when the adjustment indicative value is obtained from the sub CPU 111, the adjustment amount generating section 1144 of each of the adjusting sections 114BK, 114C, 114M and 114Y divides the number of pixels included in the single line data by (|adjustment indicative value|+1) and calculates the number of pixels included in each segment obtained by dividing the single line data into (|adjustment indicative value|+1) segments. The adjustment amount generating sections 1144 of the adjusting sections 114BK, 114C, 114M and 114Y store mutually different numerical values in the memories, and each adjustment amount generating section 1144 calculates the first adjustment amount by adding the numerical value stored in the memory to the calculated number of pixels. In addition, the adjustment amount generating section 1144 of each of the adjusting sections 114BK, 114C, 114M and 114Y calculates the second adjustment amount by adding the number of pixels included in each segment to the calculated first adjustment amount.

The adjustment amount generating section 1144 is designed to calculate the same number of adjustment amounts as the number of absolute value of the adjustment indicative value obtained from the sub CPU 111. For instance, the adjustment amount generating section 1144 calculates one adjustment amount when the adjustment indicative value is −1 or +1, and calculates two first and second adjustment amounts when the adjustment indicative value is −2 or +2.

The numerical values stored in the memories of the adjustment amount generating sections 1144 of the respective adjusting sections 114BK, 114C, 114M and 114Y are mutually different, and, for example, −100, 550, +50, and +100 are stored in the memories of the adjustment amount generating sections 1144 of the adjusting sections 114BK, 114C, 114M, and 114Y, respectively. Therefore, the adjustment amount generating sections 1144 of the respective adjusting sections 114BK, 114C, 114M and 114Y can generate mutually different first and second adjustment amounts.

The adjustment amount generating section 1144 of each of the adjusting sections 114BK, 114C, 114M and 114Y stores the generated adjustment amounts in the memory and stores information requesting to correct the image upward to the right in the memory if the adjustment indicative value obtained from the sub CPU 111 is a positive number, or stores information requesting to correct the image downward to the right in the memory if the adjustment indicative value obtained from the sub CPU 111 is a negative number. Further, when the correcting section 1145 performs the inclination adjustment process, the adjustment amount generating section 1144 of each of the adjusting sections 114BK, 114C, 114M and 114Y outputs to the correcting section 1145 the adjustment amounts stored in the memory and the information requesting to correct the image upward or downward to the right.

Here, in this embodiment, each of the adjusting sections 114BK, 114C, 114M and 114Y of the inclination adjusting section 114 has three line memories 1141, 1142 and 1143, and the correcting section 1145 can perform the process of combining line data of adjacent three lines. With such a structure, it is possible to eliminate the deviation of up to two dots between the left and right ends of the toner image in the main scanning direction. In other words, the adjustment indicative value calculated by the sub CPU 111 is either −2, −1, 0, +1, or +2. However, if each of the adjusting sections 114BK, 114C, 114M and 114Y of the inclination adjusting section 114 has four or more line memories, it is possible to perform the process of combining line data of adjacent four or more lines, and therefore it is possible to eliminate the deviation of four or more dots between the left and right ends of the toner image in the main scanning direction. In this case, the adjustment indicative value calculated by the sub CPU 111 is not limited to −2, −1, 0, +1, and +2.

Next, the following will explain the inclination adjustment process performed by the correcting section 1145, based on the adjustment amounts generated by the adjustment amount generating section 1144 of each of the adjusting sections 114BK, 114C, 114M and 114Y of the inclination adjusting section 114 as described above and the information requesting to correct the image upward or downward to the right. When the adjustment amounts generated as described above and the information are obtained from the adjustment amount generating section 1144, the correcting section 1145 determines whether or not the obtained adjustment amount is 0.

When the adjustment amount obtained from the adjustment amount generating section 1144 is 0, the image (toner image) of this color component is not inclined, and therefore the correcting section 1145 does not perform the inclination adjustment process and outputs the image data transferred from the image memory 104 as they are to the LD 1BK, 1C, 1M, 1Y of the exposure unit 1. More specifically, the correcting section 1145 reads from the third line memory 1143 the line data which was transferred from the image memory 104 and successively shift-transferred from the first line memory 1141, second line memory 1142 and third line memory 1143, and transmits the data as it is to the composition memory 1146. More specifically, the correcting section 1145 reads all the data from the first address to the last address of the third line memory 1143, and transmits the data to the composition memory 1146.

The composition memory 1146 outputs the stored line data to the corresponding LDs 1BK, 1C, 1M and 1Y of the exposure unit 1 at predetermined timing, and thereby it is possible to form the image based on the image data stored in the image memory 104 on a sheet.

When the adjustment amount generated by the adjustment amount generating section 1144 is not 0, the correcting section 1145 determines, based on the information obtained from the adjustment amount generating section 1144, whether the image should be corrected upward to the right or downward to the right, and also determines, based on whether the number of adjustment amount(s) obtained from the adjustment amount generating section 1144 is 1 or 2, how many dots the right end of the toner image should be shifted (corrected) with respect to the left end in the main scanning direction.

When a determination is made that the image should be corrected upward to the right and the number of adjustment amount obtained from the adjustment amount generating section 1144 is 1, then the correcting section 1145 determines that the image should be corrected upward to the right by one dot. In this case, the correcting section 1145 reads data from the first address to an address obtained by adding the adjustment amount to the first address in the second line memory 1142 and reads data from an address obtained by adding the adjustment amount to the first address in the third line memory 1143 to the last address, generates one-line data and transmits it to the composition memory 1146.

When a determination is made that the image should be corrected downward to the right and the number of adjustment amount obtained from the adjustment amount generating section 1144 is 1, then the correcting section 1145 determines that the image should be corrected downward to the right by one dot. In this case, the correcting section 1145 reads data from the first address to an address obtained by adding the adjustment amount to the first address in the third line memory 1143, reads data from an address obtained by adding the adjustment amount to the first address in the second line memory 1142 to the last address, generates one-line data and transmits it to the composition memory 1146.

When a determination is made that the image should be corrected upward to the right and the number of adjustment amounts obtained from the adjustment amount generating section 1144 is 2 (first adjustment amount<second adjustment amount), then the correcting section 1145 determines that the image should be corrected upward to the right by two dots. In this case, the correcting section 1145 reads data from the first address to an address obtained by adding the first adjustment amount to the first address in the first line memory 1141, reads data from an address obtained by adding the first adjustment amount to the first address in the second line memory 1142 to an address obtained by adding the second adjustment amount to the first address, reads data from an address obtained by adding the second adjustment amount to the first address in the third line memory 1143 to the last address, generates one-line data and transmits it to the composition memory 1146.

When a determination is made that the image should be corrected downward to the right and the number of adjustment amounts obtained from the adjustment amount generating section 1144 is 2 (first adjustment amount<second adjustment amount), then the correcting section 1145 determines that the image should be corrected downward to the right by two dots. In this case, the correcting section 1145 reads data from the first address in the third line memory 1143 to an address obtained by adding the first adjustment amount to the first address, reads data from an address obtained by adding the first adjustment amount to the first address in the second line memory 1142 to an address obtained by adding the second adjustment amount to the first address, reads data from an address obtained by adding the second adjustment amount to the first address in the first line memory 1141 to the last address, generates one-line data, and transmits it to the composition memory 1146.

The correcting section 1145, repeats the above-mentioned process until the process is completed on all the line data in the image data transferred from the image memory 104, and the resulting combined line data is successively stored in the composition memory 1146. Then, the line data stored in the composition memory 1146 is successively outputted to the exposure unit 1 at predetermined timing, and the LDs 1BK, 1C, M and 1Y irradiate laser light according to the inputted line data.

As described above, by detecting an actual inclination of the toner image formed based on the test line data and performing the inclination adjustment process to correct the detected inclination, even if gaps due to differences in density occur in single line data in the main scanning direction in the image data, the occurrence positions of the gaps can be varied among the respective color components as shown in FIG. 9. Hence, in the image formed based on such image data, since the positions of lines caused by the gaps and running in the sub-scanning direction vary depending on each color component, the lines are less noticeable, and thus it is possible to reduce the degradation of image quality.

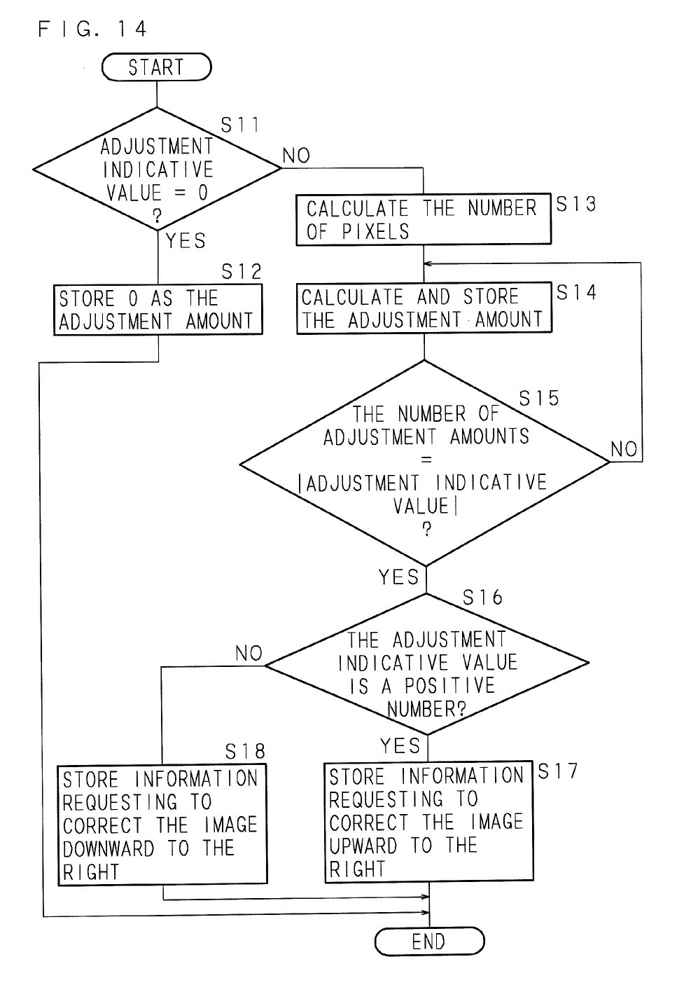

Referring to the flowchart, the following will explain the adjustment indicative value calculation process performed by the sub CPU 111. FIG. 13 is a flowchart showing the steps of the adjustment indicative value calculation process performed by the sub CPU 111. The process described below will be executed by the sub CPU 111 according to the control program stored in a memory, not shown.

When performing the adjustment indicative value calculation process, the sub CPU 111 inputs test line data to the exposure unit 1 to form a toner image based on the test line data on the surface of the intermediate transfer belt 61 (S1). The sub CPU 111 determines whether or not it has obtained output signals from the first resist sensor 65 and the second resist sensor 66 which detected the toner image formed on the intermediate transfer belt 61 (S2). If the sub CPU 111 has not obtained the output signals (S2: NO), the sub CPU 111 waits until it obtains the output signals.

When the sub CPU 111 determines that it has obtained output signals from the first resist sensor 65 and the second resist sensor 66 (S2: YES), it calculates the time difference of the detection timing of the first resist sensor 65 from the detection timing of the second resist sensor 66 (S3), and multiplies the calculated time difference by the moving speed of the intermediate transfer belt 61 to calculate a deviation in the sub-scanning direction between both end portions of the toner image based on the line data (S4).

The sub CPU 111 divides the calculated deviation by the diameter of a dot formed by the image forming section 110 to convert the deviation into the number of dots (S5), and outputs the obtained number of dots as an adjustment indicative value to the inclination adjusting section 114 (S6). The sub CPU 111 performs the process of steps S3 to S5 for each color component, and outputs the number of dots calculated for each color component to the corresponding BK adjusting section 114BK, C adjusting section 114C, M adjusting section 114M, and Y adjusting section 114Y.

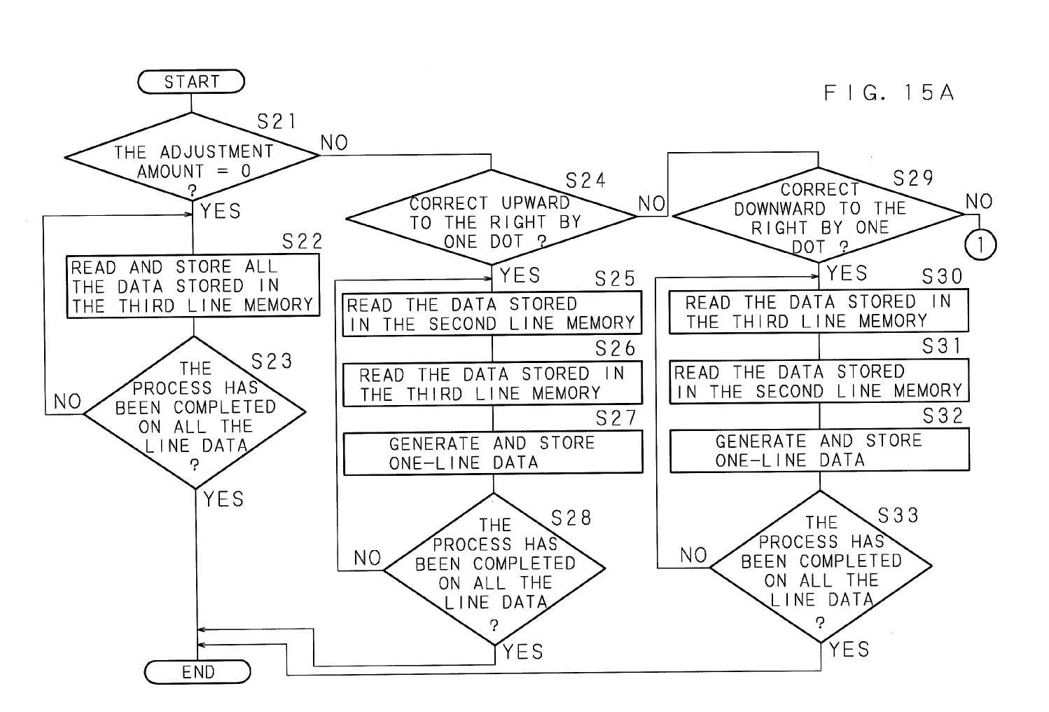

Next, referring to a flowchart, the following will explain the adjustment amount generation process performed by the adjustment amount generating sections 1144 of the respective adjusting sections 114BK, 114C, 114M and 114Y of the inclination adjusting section 114, based on the adjustment indicative value calculated by the sub CPU 111 as described above. FIG. 14 is a flowchart showing the steps of the adjustment amount generation process performed by the adjustment amount generating section 1144.

When the adjustment amount generating section 1144 obtains an adjustment indicative value from the sub CPU 111, it determines whether or not the obtained adjustment indicative value is 0 (S11). When a determination is made that adjustment indicative value is 0 (S11: YES), the adjustment amount generating section 1144 stores 0 as the adjustment amount in the memory (S12) and finishes the adjustment amount generation process.

When a determination is made that the obtained adjustment indicative value is not 0 (S11: NOD), the adjustment amount generating section 1144 divides the number of pixels contained in one-line data by (|adjustment indicative value|+1) to calculate the number of pixels contained in each segment obtained by dividing the one-line data into (|adjustment indicative value|+1) segments (S13). The adjustment amount generating section 1144 calculates an adjustment amount (first adjustment amount) by adding a predetermined numerical value stored in the memory to the calculated number of pixels and stores the adjustment amount in the memory (S14).

The adjustment amount generating section 1144 determines whether or not the calculated number of adjustment amounts is equal to |adjustment indicative value| (S15). If NOT (S15: NO), the adjustment amount generating section 1144 returns the process to step S14, adds the number of pixels contained in each segment calculated in step S13 to the calculated adjustment amount (first adjustment amount) to calculate an adjustment amount (second adjustment amount) and stores the adjustment amount in the memory (S14).

When a determination is made that the calculated number of adjustment amounts is equal to |adjustment indicative value| (S15: YES), the adjustment amount generating section 1144 determines whether or not the adjustment indicative value obtained from the sub CPU 111 is a positive number (S16). When the adjustment amount generating section 1144 determines that the adjustment indicative value is a positive number (S16: YES), it stores information requesting to correct the image upward to the right in the memory (S17). On the other hand, when the adjustment amount generating section 1144 determines that the adjustment indicative value is not a positive number (S16: NO), that is, the adjustment indicative value is a negative value, it stores information requesting to correct the image downward to the right in the memory (S18) and completes the above mentioned process.

As described above, in this embodiment, each of the adjusting sections 114BK, 114C, 114M and 114Y of the inclination adjusting section 114 generates an adjustment amount based on the adjustment indicative value obtained from the sub CPU 111. However, for example, it is also possible to design the sub CPU 111 to generate an adjustment amount for the inclination adjustment process which is performed on image data of each color component by the respective adjusting sections 114BK, 114C, 114M and 114Y. In this case, the adjustment amount generating sections 1144 of the respective adjusting sections 114BK, 114C, 114M and 114Y are not necessary, and the correcting section 1145 may perform the inclination adjustment process based on the adjustment amounts obtained from the sub CPU 111.

Moreover, in this embodiment, different numerical values are stored in advance in the memories of the adjusting sections 114BK, 114C, 114M and 114Y of the inclination adjusting section 114, so that adjustment amounts generated by the respective adjustment amount generating sections 1144 based on these numerical values differ from each other. Therefore, for example, even when the black and cyan images are not inclined, the adjustment amount generating sections of the M adjusting section 114M and Y adjusting section 114Y calculate, based on the numerical values stored in their memories, adjustment amounts for the inclination adjustment process which is performed on the magenta and yellow image data. However, in the case where the sub CPU 111 generates adjustment amounts as described above, it is possible to appropriately calculate an adjustment amount for each color component, based on the inclination direction and inclination amount of each color component. Hence, when there is a color component which does not have inclination, adjustment amounts can be calculated by taking this fact into account.

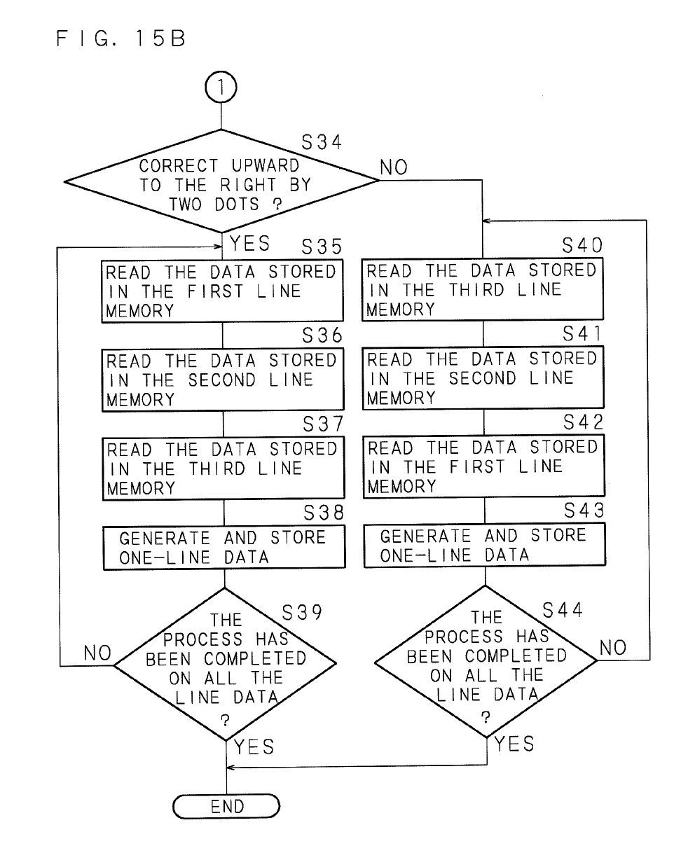

Next, referring to a flowchart, the following will explain the inclination adjustment process performed by the correcting section 1145, based on an adjustment amount generated by the adjustment amount generating section 1144 of each adjusting section 114BK, 114C, 114M, or 114Y of the inclination adjusting section 1114 as described above and information requesting to correct the image upward, or downward, to the right. FIG. 15A and FIG. 15B are flowcharts showing the inclination adjustment process performed by the correcting section 1145.

When the correcting section 1145 obtains an adjustment amount from the adjustment amount generating section 1144 and information requesting to correct the image upward, or downward, to the right, it determines whether or not the obtained adjustment amount is 0 (S21). If 0 (S21: YES), the correcting section 1145 reads all the data stored in the third line memory 1143 and stores the data in the composition memory 1146 (S22). The composition memory 1146 outputs the stored line data successively to the exposure unit 1. The correcting section 1145 determines whether or not the process has been completed on all the line data in the image data transferred from the image memory 104 (S23). If NOT (S23: NO), the correcting section 1145 repeats the process of step S22 until the process is completed. When the correcting section 1145 determines that the process has been completed (S23: YES), it completes the inclination adjustment process.

When the correcting section 1145 determines that the obtained adjustment amount is not 0 (S21: NO), it determines, based on the information obtained from the adjustment amount generating section 1144 and the number of the adjustment amount, whether or not the image should be corrected upward to the right by one dot (S24). When a determination is made that the image should be corrected upward to the right by one dot (S24: YES), the correcting section 1145 reads data from the first address in the second line memory 1142 to an address obtained by adding the adjustment amount to the first address (S25), reads data from an address obtained by adding the adjustment amount to the first address in the third line memory 1143 to the last address (S26), and generates one-line data and stores it in the composition memory 1146 (S27).

The correcting section 1145 determines whether or not the process has been completed on all the line data in the image data transferred from the image memory 104 (S28). If NOT (S28: NO), the correcting section 1145 repeats the process of steps S25 to S27 until the process is completed. When a determination is made that the process has been completed (S28: YES), the correcting section 1145 completes the inclination adjustment process.

When the correcting section 1145 does not determine to correct the image upward to the right by one dot (S24: NO), it determines, based on the information obtained from the adjustment amount generating section 1144 and the number of the adjustment amount, whether or not the image should be corrected downward to the right by one dot (S29). When the correcting section 1145 determines that the image should be corrected downward to the right by one dot (S29: YES), it reads data from the first address in the third line memory 1143 to an address obtained by adding the adjustment amount to the first address (S30), reads data from an address obtained by adding the adjustment amount to the first address in the second line memory 1142 to the last address (S31), and generates one-line data and stores it in the composition memory 1146 (S32).

The correcting section 1145 determines whether or not the process has been completed on all the line data in the image data transferred from the image memory 104 (S33). If NOT (S33: NO), the correcting section 1145 repeats the process of steps S30 to S32 until the process is completed. When a determination is made that the process has been completed (S33: YES), the correcting section 1145 completes the inclination adjustment process.

When the correcting section 1145 does not determine to correct the image downward to the right by one dot (S29: NO), it determines, based on the information obtained from the adjustment amount generating section 1144 and the number of the adjustment amount, whether or not the image should be corrected upward to the right by two dots (S34). When the correcting section 1145 determines that the image should be corrected upward to the right by two dots (S34: YES), it reads data from the first address in the first line memory 1141 to an address obtained by adding the first adjustment amount to the first address (S35), reads data from an address obtained by adding the first adjustment amount to the first address in the second line memory 1142 to an address obtained by adding the second adjustment amount to the first address (S36), reads data from an address obtained by adding the second adjustment amount to the first address in the third line memory 1143 to the last address (S37), and generates one-line data and stores it in the composition memory 1146 (S38).

The correcting section 1145 determines whether or not the process has been completed on all the line data in the image data transferred from the image memory 104 (S39). If NOT (S39: NO), the correcting section 1145 repeats the process of steps S35 to S38 until the process is completed. When a determination is made that the process has been completed (S39: YES), the correcting section 1145 completes the inclination adjustment process.

When the correcting section 1145 does not determine to correct the image upward to the right by two dots (S34: NO), that is, when the image should be corrected downward to the right by two dots, it reads data from the first address in the third line memory 1143 to an address obtained by adding the first adjustment amount to the first address (S40), reads data from an address obtained by adding the first adjustment amount to the first address in the second line memory 1142 to an address obtained by adding the second adjustment amount to the first address (S41), reads data from an address obtained by adding the second adjustment amount to the first address in the first line memory 1141 to the last address (S42), and generates one-line data and stores it in the composition memory 1146 (S43).

The correcting section 1145 determines whether or not the process has been completed on all the line data in the image data transferred from the image memory 104 (S44). If NOT (S44: NO), the correcting section 1145 repeats the process of steps S40 to S43 until the process is completed. When a determination is made that the process has been completed (S44: YES), the correcting section 1145 completes the inclination adjustment process.

By performing the inclination adjustment process as described above, even when gaps due to differences in density occur in single line data in the main scanning direction in the image data, the occurrence positions of the gaps can be varied among the respective color components as shown in FIG. 9. Hence, in the image formed based on such image data, since the positions of lines caused by the gaps and running in the sub-scanning direction vary depending on each color component, the lines are less noticeable, and thus it is possible to reduce the degradation of image quality.

In the above-described embodiment, the inclination adjusting section 114 of the image forming section 110 comprises the BK adjusting section 114BK, C adjusting section 114C, M adjusting section 114M, and Y adjusting section 114Y to perform an inclination adjustment process (correction process) on each image data of black, cyan, magenta, or yellow color. However, even if an inclination adjustment process is performed to adjust, based on one color as a reference color, image data of other color component according to the inclination of the image (toner image) of the reference color, it is possible to reduce deviations among the respective colors.

More specifically, an inclination of an image is detected from the image formed based on the image data of the reference color, and then the correction process according to the detected inclination is executed on image data of other color. With this structure, since there is no need to perform the inclination adjustment process on the image data of the reference color, it is possible to reduce the circuit scale. Moreover, for example, the adhesion of other color to the periphery of black letters (letter edge) degrades the image quality of the letters to a large degree, but, if black is used as the reference color, out-of-color registration of image data of other color with respect to the black image data is reduced, thereby improving the letter edge and forming a good image.

The above-described embodiment explains a structure in which an adjustment amount needed for the inclination adjusting section 114 to perform an inclination adjustment process based on image data is calculated from a toner image based on test line data. However, it is also possible to calculate an adjustment amount based on a toner image formed on the intermediate transfer belt 61 during normal operation. In this case, it is possible to correct not only an inclination of the toner image caused by displacements of the installation angles of the exposure unit 1, photosensitive drum 3, intermediate transfer unit 60 etc., but also an inclination of the toner image due to displacements of the exposure unit 1, photosensitive drum 3, intermediate transfer unit 60 etc. caused by the operation of the image forming apparatus 100.

The above-described embodiment explains an example in which the image forming apparatus of the present invention is applied to a digital color all-in-one machine. However, it is also possible to apply the present invention to various types of image forming apparatuses having a printer function, a copy function, a scanner function, and a facsimile function. Further, although the image forming apparatus 100 of the above-described embodiment is an example of intermediate transfer type structure for forming a color image, it is also possible to apply the present invention to, for example, an image forming apparatus having a structure in which toner images formed on photosensitive drums corresponding to the respective colors and arranged in tandem are successively transferred onto a transported sheet.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. An image processing apparatus comprising:
an image data obtaining section for obtaining image data including a plurality of line data for each of a plurality of color components; and
a controller capable of
setting positions for dividing each line data individually for each color component,
dividing each line data in the obtained image data into a plurality of segments at said set positions, and
performing, for each of the divided segments, a process of correcting an inclination of an image based on the line data.

2. The image processing apparatus as set forth in claim 1, comprising line memories for storing a plurality of line data,
wherein said controller corrects an inclination of the image based on the line data by combining a plurality of line data stored in said line memories.

3. The image processing apparatus as set forth in claim 1, wherein
said controller detects an inclination direction and an inclination amount of an image based on image data, and performs a process of correcting the detected inclination direction and inclination amount.

4. The image processing apparatus as set forth in claim 3, comprising a forming section for forming a test image based on predetermined test line data, wherein
said controller detects positions of both end portions in a longitudinal direction of the formed test image, along a direction crossing the longitudinal direction, and detects an inclination direction and an inclination amount of the image, based on the detected positions.

5. The image processing apparatus as set forth in claim 3, wherein
said controller calculates, based on the detected inclination direction and inclination amount, an adjustment amount for a position of dividing each line data for each color component, and sets positions for dividing each line data individually for each color component based on the calculated adjustment amount.

6. The image processing apparatus as set forth in claim 3, wherein
said controller detects an inclination direction and an inclination amount of an image based on image data of one color component, and performs a process of correcting image data of other color component according to the detected inclination direction and inclination amount.

7. The image processing apparatus as set forth in claim 6, wherein
said one color component is black component.

8. An image forming apparatus comprising:
an image processing apparatus as set forth in claim 1; and
an image forming section for forming on a recording medium an image based on image data processed by said image processing apparatus.

9. An image forming apparatus comprising:
an intermediate transfer belt;
a transfer section for transferring a test developer image based on predetermined test line data onto said intermediate transfer belt;
an image data obtaining section for obtaining image data including a plurality of line data for each of a plurality of color components; and
a controller capable of
detecting positions of both end portions in a longitudinal direction of the test developer image transferred onto said intermediate transfer belt, along a direction crossing the longitudinal direction,
detecting an inclination direction and an inclination amount of the test developer image, based on the detected positions,
setting positions for dividing each line data individually for each color component,
dividing each line data in the image data obtained by said image data obtaining section into a plurality of segments at said set positions, and
performing a process of correcting the detected inclination direction and inclination amount for each of the divided segments,
wherein said transfer section transfers a developer image based on the image data corrected by said controller onto said intermediate transfer belt.

10. An image processing apparatus comprising:
an image data obtaining section for obtaining image data including a plurality of line data for each of a plurality of color components;
setting means for setting positions for dividing each line data individually for each color component,
segmenting means for dividing each line data in the obtained image data into a plurality of segments at said set positions; and
correcting means for performing, for each segment divided by said segmenting means, a process of correcting an inclination of an image based on the line data.

11. The image processing apparatus as set forth in claim 10, comprising line memories for storing a plurality of line data,
wherein said correcting means comprises means for combining a plurality of line data stored in said line memories.

12. The image processing apparatus as set forth in claim 10, comprising detecting means for detecting an inclination direction and an inclination amount of an image based on image data,
wherein said correcting means performs a process of correcting the inclination direction and inclination amount detected by said detecting means.

13. The image processing apparatus as set forth in claim 12, comprising:
a forming section for forming a test image based on predetermined test line data; and
means for detecting positions of both end portions in a longitudinal direction of the formed test image, along a direction crossing the longitudinal direction,
wherein said detecting means detects an inclination direction and an inclination amount of the image, based on the detected positions.

14. The image processing apparatus as set forth in claim 12, comprising means for calculating, based on the inclination direction and inclination amount detected by said detecting means, an adjustment amount for a position for said segmenting means to divide each line data, for each color component
wherein said setting means sets, based on the calculated adjustment amount, positions for said segmenting means to divide each line data, for each color component.

15. The image processing apparatus as set forth in claim 12, wherein
said detecting means detects an inclination direction and an inclination amount of an image based on image data of one color component, and
said correcting means performs a process of correcting image data of other color component according to the inclination direction and inclination amount detected by said detecting means.

16. The image processing apparatus as set forth in claim 15, wherein said one color component is black component.

17. An image forming apparatus comprising:
an image processing apparatus as set forth in claim 10; and
an image forming section for forming on a recording medium an image based on image data processed by said image processing apparatus.
